(19) United States
(12) Patent Application Publication
(10) Pub. No.: US 2016/0098692 A1
(43) Pub. Date: Apr. 7, 2016

(54) METHOD FOR PROCESSING TRANSACTION STATEMENT INQUIRIES VIA AN ATM

(71) Applicant: Bank of America Corporation, Charlotte, NC (US)

(72) Inventors: Tyler Johnson, Tega Cay, SC (US); Christian Michael Mande, Charlotte, NC (US); James Robert Grimsley, Dover, FL (US); Sara Gill, New York, NY (US); Nathan Dent, Concord, NC (US); Kristy M. Crist, Charlotte, NC (US)

(21) Appl. No.: 14/506,479

(22) Filed: Oct. 3, 2014

(51) Int. Cl. G06Q 20/10; G06F 17/30; G06Q 40/00

(52) U.S. Cl. CPC G06Q 20/1085; G06Q 40/12; G06F 17/30876

(57) ABSTRACT

Disclosed is an automated teller machine (ATM) configured for processing transaction statement inquiries. The ATM also typically includes a processor, a memory, and a module stored in the memory. The module is typically configured to: receive a first request from a user to view a transaction statement; present the transaction statement on a display associated with the automated teller machine, wherein the transaction statement comprises one or more line items corresponding to one or more transaction associated with the user account; receive a second request from the user to select at least one line item within the transaction statement for inquiry processing; and process at least one action for the at least one line item based at least partially on the second request from the user to select the at least one line item within the transaction statement for inquiry processing.

### FIELD OF THE INVENTION

The present invention embraces an automated teller machine (ATM) configured for processing transaction statement inquiries. In this regard, the ATM is typically configured to: present a transaction statement on a display associated with the automated teller machine, wherein the transaction statement includes one or more line items; receive a request from the user to select at least one line item within the transaction statement for inquiry processing; and process at least one action for the at least one line item based at least partially on the request from the user to select the at least one line item within the transaction statement for inquiry processing.

### BACKGROUND

Automated Teller Machines (ATMs) are a predominant banking channel for the vast majority of customer transactions, especially cash withdrawals, cash/checking deposits or account balance inquiries. Currently, customers may conduct banking transactions, such as cash withdrawals, cash/checking deposits, account transfers, balance inquiries and the like, at an ATM. There is a desire to improve privacy for ATM users.

### SUMMARY

In one aspect, the present invention embraces an automated teller machine that includes a display; a computing device including a memory; at least one processor; and an ATM application stored in the memory and executable by the processor. The ATM application is typically configured for: displaying public information on the display; initiating an ATM session with a user; based on initiating the ATM session with the user, initiating a privacy protocol, the privacy protocol reducing the viewability of at least a portion of the display; receiving user-specific information; and, during the ATM session with the user and based on receiving the user-specific information, displaying the user-specific information on the portion of the display having reduced viewability.

In a particular embodiment, the display includes (i) a first display layer having a wide viewing cone, the first display layer defining an outer layer of the display, (ii) a second display layer, the second display layer defining an inner layer of the display, and (iii) a privacy filter positioned between the first display layer and the second display layer and overlaying the second display layer so that the second display layer has a narrow viewing cone. The first display layer is typically capable of being sufficiently transparent and/or translucent so that information displayed on the second display layer can be discerned within the second display layer's narrow viewing cone. Displaying the user-specific information on the portion of the display having reduced viewability typically includes displaying the user-specific information on the second display layer.

In another particular embodiment, the ATM application is configured for concurrently displaying the public information on the first display layer and the user-specific information on the second display layer, wherein the public information displayed on the first display layer does not obstruct the user-specific information displayed on the second display layer.

In yet another particular embodiment, the privacy filter includes a diffraction filter or a diffusion filter that obscures information displayed on the second display layer to observers outside the narrow viewing cone.

In yet another particular embodiment, the automated teller machine includes one or more speakers configured to direct sound to the user, and the ATM application is configured for, during the ATM session with the user and based on receiving the user-specific information, communicating the user-specific information to the user via the one or more speakers.

In yet another particular embodiment, the public information includes one or more advertisements and/or information regarding a financial institution's locations, contact information, products, and/or services.

In yet another particular embodiment, the user-specific information includes user account information, a user-specific message, and/or a user-specific advertisement and/or offer.

In another aspect, the present invention embraces a computer program product for operating an automated teller machine having a display, the computer program product comprising a non-transitory computer-readable storage medium having computer-executable instructions for: displaying public information on the display; initiating an ATM session with a user; based on initiating the ATM session with the user, initiating a privacy protocol, the privacy protocol reducing the viewability of at least a portion of the display; receiving user-specific information; and, during the ATM session with the user and based on receiving the user-specific information, displaying the user-specific information on the portion of the display having reduced viewability.

In yet another aspect, the present invention embraces a method for operating an automated teller machine having a display, the method comprising: displaying, via a computer processor, public information on the display; initiating, via a computer processor, an ATM session with a user; based on initiating the ATM session with the user, initiating, via a computer processor, a privacy protocol, the privacy protocol reducing the viewability of at least a portion of the display; receiving, via a computer processor, user-specific information; and, during the ATM session with the user and based on receiving the user-specific information, displaying, via a computer processor, the user-specific information on the portion of the display having reduced viewability.

In yet another aspect, the present invention embraces an automated teller machine (and an associated method and computer program product) that directly communicates with consumer devices to provide privacy. The automated teller machine typically includes a memory, one or more computing processors, and a module stored in the memory. The module typically includes instruction codes executable by one or more computing processors and configured to cause the computing processors to: initiate, at the automated teller machine, an ATM session with a user; associate at least one user mobile computing device with the ATM session; process, at the automated teller machine, a first transaction request on behalf of the user during the ATM session; and in response to processing the first transaction request, initiate an interactive session between the ATM and the user mobile computing device, wherein information associated with the first transaction request is communicated to the user mobile computing device during the interactive session.

In a particular embodiment, the module is further configured to cause one or more computing processors to authenticate the user's identity prior to initiating the ATM session with the user.

In another particular embodiment, the module is further configured to cause one or more computing processors to: receive, from the user, a request to associate the at least one user mobile computing device with the ATM session; prompt the user to provide contact information related to the at least one user mobile computing device; and receive user input providing contact information related to the at least one user mobile computing device prior to associating the at least one user device with the ATM session.

In another particular embodiment, the module is further configured to cause one or more computing processors to establish a wireless network connection between the automated teller machine and the at least one user mobile computing device during the interactive session.

In another particular embodiment, the interactive session is conducted via at least one a phone call to the user mobile computer device or via a mobile banking application on the user mobile device.

In another particular embodiment, initiating the interactive session in response to processing the first transaction request comprises initiating the interactive session in response to detecting a processing failure.

In another particular embodiment, the module is further configured to cause one or more computing processors to, during both the ATM session and interactive session, receive a second transaction request from the user mobile device.

In yet another aspect, the present invention embraces an automated teller machine (and an associated method and computer program product) that processes transaction statement inquiries for users. The automated teller machine typically includes a memory, one or more computing processors, and a module stored in the memory. The module typically includes instruction codes executable by one or more computing processors and configured to cause the computing processors to: receive a first request from a user, via the automated teller machine, to view a transaction statement, wherein the automated teller machine is maintained by a financial institution, and wherein the user has an account with the financial institution; present the transaction statement on a display associated with the automated teller machine, wherein the transaction statement comprises one or more line items corresponding to one or more transaction associated with the user account; receive a second request from the user, via the automated teller machine, to select at least one line item within the transaction statement for inquiry processing; and process at least one action for the at least one line item based at least partially on the second request from the user to select the at least one line item within the transaction statement for inquiry processing.

In a particular embodiment, the module is further configured to cause one or more computing processors to authenticate the user's identity prior to receiving the first request from the user.

In another particular embodiment, the first request comprises one or more user specifications for presenting the transaction statement, and wherein at least one of the specifications comprises a request to present a full transaction statement for the current statement cycle.

In another particular embodiment, wherein the first request comprises one or more user specifications for presenting the transaction statement, and wherein at least one of the specifications comprises a request to present a partial transaction statement based on the one or more user specification.

In another particular embodiment, the module is further configured to cause one or more computing processors to present the transaction statement on the display associated with the automated teller machine based at least partially one or more user preferences. The user preferences may include highlighting a particular transaction type within the transaction statement.

In another particular embodiment, the module is further configured to cause one or more computing processors to present the transaction statement on the display associated with the automated teller machine based at least partially one or more user preferences, and wherein the user preferences specify the type of transaction details to be included within the transaction statement.

In another particular embodiment, the module is further configured to cause one or more computing processors to modify the transaction statement in real time based at least partially on a user request to modify the transaction statement presented on the display associated with the automated teller machine. The user request may include (i) a request to filter one or more lines items within the transaction statement, (ii) a request to sort one or more lines items within the transaction statement, and/or (iii) a request to present one or more pending transactions within the transaction statement.

In another particular embodiment, the module is further configured to cause one or more computing processors to present the user with an option to select all line items within the transaction statement for inquiry processing.

In another particular embodiment, the module is further configured to cause one or more computing processors to select at least one transaction for inquiry processing based at least partially on one or more trends detected within the user's transaction history.

In another particular embodiment, the at least one action comprises creating a portable document format (PDF) document that contains transaction details for the at least one line item selected.

In another particular embodiment, the at least one action comprises flagging the at least one line item selected for follow-up.

In another particular embodiment, the at least one action comprises disputing the at least one line item selected for follow-up.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 depicts an automated teller machine (ATM) in accordance with an aspect of the present invention;

FIG. 2 depicts a display of an ATM having both a relatively wide viewing cone and a relatively narrow viewing cone in accordance with an aspect of the present invention;

FIG. 3A depicts a front view of an ATM display with an overlaid privacy filter in accordance with one embodiment of the present invention;

FIG. 3B depicts a cross sectional view of an ATM display in accordance with another embodiment of the present invention;

FIG. 4 depicts an environment in which an ATM is in communication with a banking system in accordance with an aspect of the present invention;

FIG. 5 schematically depicts a banking system in accordance with an aspect of the present invention;

FIG. 6 depicts a method of displaying information on an ATM display in accordance with an aspect of the present invention;

FIG. 7 depicts an environment in which an ATM is in communication with a banking system, user interface device, and mobile computing device in accordance with another aspect of the present invention;

FIG. 8 schematically depicts a user interface device in accordance with another aspect of the present invention;

FIG. 9 schematically depicts a mobile computing device in accordance with another aspect of the present invention;

FIG. 10 depicts a method of providing privacy through ATM communication with consumer devices in accordance with another aspect of the present invention;

FIG. 11 depicts a method of processing transaction statement inquiries via an ATM, in accordance with yet another aspect of the present invention;

FIG. 12 depicts a transaction statement view presented on an ATM display, in accordance with yet another aspect of the present invention; and

FIG. 13 depicts a method of disputing a transaction, in accordance with yet another aspect of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In some embodiments, an “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, a non-monetary user profile that includes only personal information associated with the user, or the like. The account is associated with and/or maintained by an entity. In other embodiments, an “entity” may not be a financial institution.

In some embodiments, the “user” may be a customer (e.g., an account holder or a person who has an account (e.g., banking account, credit account, or the like) at the entity) or potential customer (e.g., a person who has submitted an application for an account, a person who is the target of marketing materials that are distributed by the entity, a person who applies for a loan that not yet been funded). In other embodiments, the “customer” may refer to the user.

The embodiments described herein may refer to ATM transactions. Unless specifically limited by the context, a “transaction” refers to any communication between the user and the financial institution or other entity monitoring the user's activities. In typical embodiments, for example, a transaction may refer to a payment transaction, a credit transaction, a cash withdrawal, making a deposit to a bank account, transferring balances from one account to another account, or other interaction at an ATM involving a user's bank account. As used herein, a “bank account” refers to a credit account, a debit/deposit account, or the like. Although the phrase “bank account” includes the term “bank,” the account need not be maintained by a bank and may, instead, be maintained by other financial institutions. For example, in the context of a financial institution, a transaction may refer to one or more of a sale of goods and/or services, an account balance inquiry, a rewards transfer, an account money transfer, opening a bank application on a user's computer or mobile device, a user accessing his or her e-wallet or any other interaction involving the user. A transaction may occur when a user accesses a building, uses a rewards card, and/or performs an account balance query. A transaction may occur as a user's device establishes a wireless connection, such as a Wi-Fi connection, with an ATM. In some embodiments, a transaction may include one or more of the following: purchasing, renting, selling, and/or leasing goods and/or services (e.g., groceries, stamps, tickets, DVDs, vending machine items, and the like); withdrawing cash; making payments to creditors (e.g., paying monthly bills; paying federal, state, and/or local taxes; and the like); sending remittances; transferring balances from one account to another account; loading money onto stored value cards (SVCs) and/or prepaid cards; donating to charities; and/or the like.

In one aspect, the present invention generally relates to an automated teller machine (ATM) that is configured to implement a privacy protocol during a user ATM session. This protocol is typically configured to reduce the viewabilty of at least some information (e.g., user-specific information) displayed on the ATM's display during the ATM session. In a particular embodiment, the ATM may be configured to ordinarily display information using a wide viewing cone; however, during a user ATM session the privacy protocol may cause the ATM to display at least some information (e.g., information regarding a user's account(s)) using a narrow viewing cone. By reducing the viewability of information displayed on the ATM's display, a user of the ATM may be able to perceive this information, but other individuals may not be able to easily perceive this displayed information. Accordingly, the ATM's display can be used to display both (i) non-private information (e.g., advertisements and/or information regarding a financial institution's locations, contact information, products, and/or services) that can be perceived by many individuals near the ATM and (ii) private, user-specific information that can only be perceived easily by a user engaged in an ATM session.

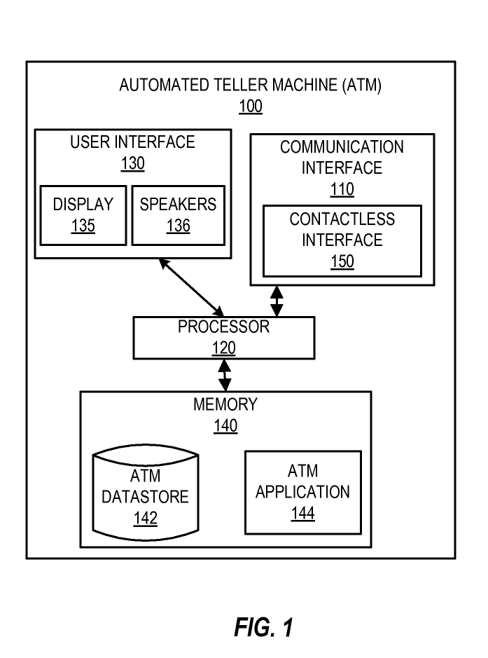

Accordingly, FIG. 1 depicts an ATM 100 in accordance with an aspect of the present invention. As depicted in FIG. 1, the ATM 100 typically includes a communication interface 110, a processor 120, a user interface 130 that includes a display 135, and a memory 140 having an ATM datastore 142 and an ATM application 144 (e.g., ATM module) stored therein. As discussed in more detail below, the ATM application is typically configured to implement a privacy protocol during an ATM session with a user that reduces the viewability of at least some information displayed on the display 135. As shown, the processor 120 is operatively connected to the communication interface 110, the user interface 130, and the memory 140.

The communication interface 110 may generally include a modem, server, transceiver, and/or other device for communicating with other devices and systems on a network. The communication interface 110 of the ATM may also include a contactless interface 150. In one embodiment, the contactless interface is an NFC interface. The contactless interface 150 is configured to contactlessly and/or wirelessly send and/or receive information over relatively short ranges (e.g., within four inches, within three feet, and the like). The contactless interface 150 may include a transmitter, receiver, smart card, key card, proximity card, Bluetooth® device, radio frequency identification (RFID) tag and/or reader, and/or the like. In some embodiments, the contactless interface 150 communicates information via radio, IR, Bluetooth® low energy, iBeacon®, AirDrop®, Bump, and/or optical transmissions. Generally, the contactless interface 150 is configured to operate as a contactless transmitter and/or as a contactless receiver. The contactless interface 150 functions to enable transactions with users utilizing an external apparatus capable of contactless communication. Also, it will be understood that the contactless interface 150 may be embedded, built, carried, and/or otherwise supported in and/or on the ATM 100. In some embodiments, the contactless interface 150 is not supported in and/or on the ATM 100, but the contactless interface 150 is otherwise operatively connected to the ATM 100 (e.g., where the contactless interface 150 is a peripheral device plugged into the ATM 100). The contactless interface 150 of the ATM 100 is configured to contactlessly and/or wirelessly communicate information to and/or from an external device (e.g., a user's mobile device).

The processor 120, and other processors described herein, typically includes circuitry for implementing communication and/or logic functions of a particular device or system (e.g., the ATM 100). For example, the processor 120 may include a digital signal processor device, a microprocessor device, and various analog to digital converters, digital to analog converters, and/or other support circuits. Control and signal processing functions of the ATM 100 are allocated between these devices according to their respective capabilities. The processor 120 thus may also include the functionality to encode and interleave messages and data prior to modulation and transmission. The processor 120 can additionally include an internal data modem. Further, the processor 120 may include functionality to operate one or more software programs, including the ATM application 144, which may be stored in the memory 140.

The user interface 130 of the ATM 100 includes the display 135 (e.g., a liquid crystal display, a touchscreen display, and/or the like) which is operatively coupled to the processor 120. The user interface 130 may also include any number of other devices allowing the ATM 100 to transmit/receive data to/from a user, such as a keypad, keyboard, touch-screen, touchpad, microphone, mouse, joystick, other pointer device, button, soft key, receipt printers, dispensers (e.g., cash dispensers, ticket dispensers, merchandise dispensers, and the like), card readers (e.g., for reading the magnetic strip on magnetic cards such as ATM, debit, credit, and/or bank cards, and the like), deposit mechanisms (e.g., for depositing checks and/or cash, and the like), and/or other input/output device(s). As depicted in FIG. 1, the user interface 130 may include one or more speakers 136. The speakers 136 may be configured to direct sound so that a user of the ATM 100 can hear sound from the speakers 136, but others cannot hear such sound. Accordingly, the speakers 136 may be used to provide private information (e.g., account information) to a user of the ATM 100 (e.g., a visually impaired user).

Generally, an observer (e.g., an observer walking past the ATM) is able to discern text or other information displayed on the display 135 at most angles, including most viewing angles for observers not using the ATM. In other words, even if a first observer is standing directly in front of the ATM 100 in order to conduct an ATM transaction, a second observer may be able to discern information displayed on the display 135. Therefore, the ATM application is typically configured to implement a privacy protocol during an ATM session with a user that reduces the viewability of at least some information displayed on the display 135, so other individuals (e.g., an observer walking past the ATM) will have difficulty discerning displayed information (e.g., difficulty reading displayed text), but so the user can still discern displayed information. In some embodiments, the viewabilty of the entire display may be reduced. That said, in other embodiments the viewabilty of a portion (e.g., a central portion where user-specific information is displayed) of display may be reduced. Reducing the viewability of information (e.g., user-specific information) displayed on the display 135 may be performed by reducing the size (e.g., text size) of displayed information. Reducing the viewability of information (e.g., user-specific information) displayed on the display 135 may also be performed by altering display characteristics (e.g., brightness, contrast, sharpness, color, and/or the like) of at least a portion of the display 135 (e.g., a central portion of the display). In another embodiment, reducing the viewability of information displayed on the display 135 may be performed by employing one or more lenses that can be used to change the focal point of the display 135 (e.g., so that a user of the ATM can discern information on the display but others cannot) once the privacy protocol has been implemented. Although several ways of reducing the viewability of the display 135 have been described, it is within the scope of the present invention to employ any way of reducing the viewability of the display 135.

In one embodiment, altering display characteristics of at least a portion of the display 135 (e.g., alter certain pixels of the display 135) may change the viewing cone of at least a portion of the display 135. A viewing cone is the range of viewing directions in which a display can be viewed with acceptable visual performance (e.g., an observer being able to discern displayed text). Each viewing cone defines a viewing angle θ, which reflects the maximum angle at which a display can be viewed with acceptable visual performance. The viewing angle θ measured from one direction to the opposite direction and, thus, is typically twice the maximum angle having acceptable visual performance measured relative to the surface normal of the display.

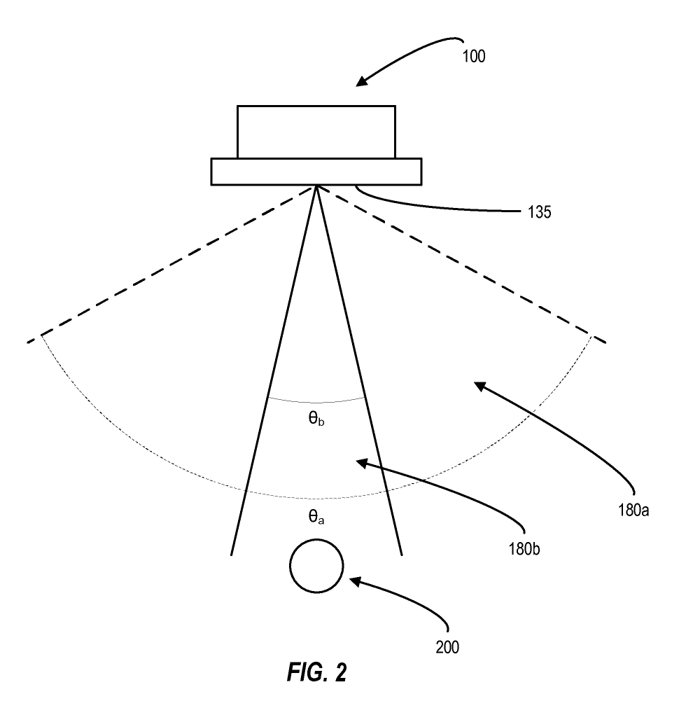

In this regard, FIG. 2 depicts the display 135 ordinarily having a relatively wide first viewing cone 180a. FIG. 2 also depicts the display (or a portion of the display) having a relatively narrow second viewing cone 180b after the privacy protocol alters display characteristics of the display 135. The first viewing cone 180a defines a viewing angle θa in which an observer 200 can ordinarily view the display 135 with acceptable visual performance. By way of example, the viewing angle θa may be between about 180 degrees and 120 degrees. Accordingly, an observer (e.g., an observer walking past the ATM) is ordinarily able to discern text or other information displayed on the display at most angles, including most viewing angles for an observer not using the ATM. If the privacy protocol only alters display characteristics of a central portion of the display 135, then, even if a first observer is standing directly in front of the ATM 100 in order to conduct an ATM transaction, a second observer may be able to discern information displayed on portions of the display 135 other than the altered central portion.

The second viewing cone 180b of the display 135 defines a viewing angle θb in which the observer 200 can view certain information (e.g., user-specific information) on the display 135 with acceptable visual performance once the privacy protocol has been implemented. The viewing angle θb is typically an angle at which the observer 200, when using the ATM, is able to discern text or other information displayed on the display 135, but other observers are typically unable to discern text or other information displayed on the display 135. For example, the viewing angle θb may be between about 60 degrees and 30 degrees.

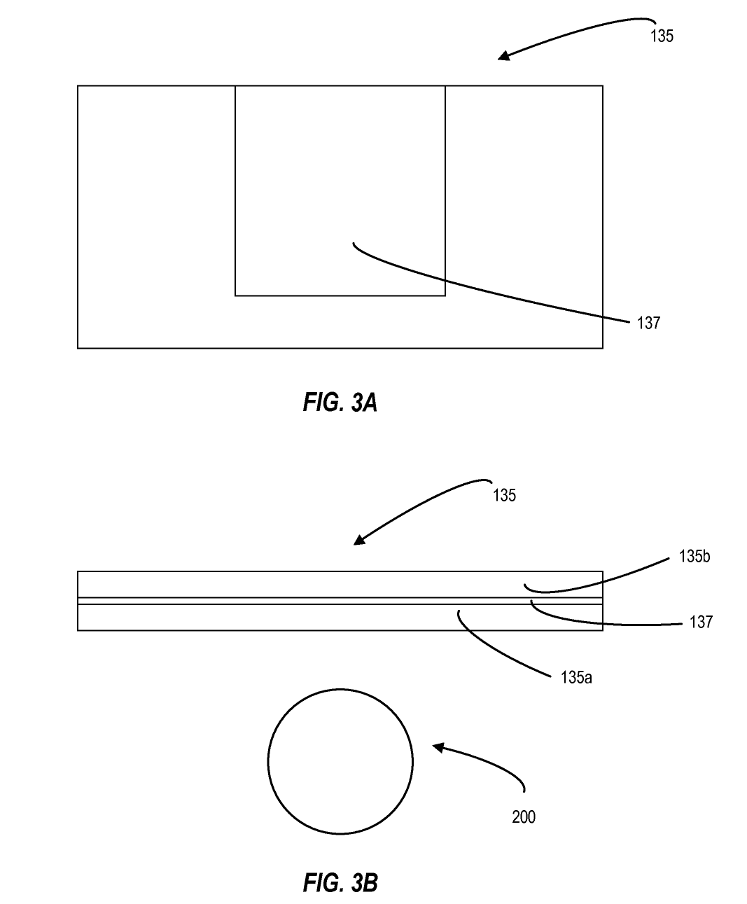

Although altering display characteristics of at least a portion of the display 135 (e.g., alter certain pixels of the display 135) is one way of providing a display that can employ wide and narrow viewing cones, any other way of providing a display that can employ wide and narrow viewing cones is within the scope of the present invention. For example, in another embodiment depicted in FIG. 3A, a privacy filter 137 may be positioned over at least a portion (e.g., a central portion) of the display 135. The privacy filter may be a diffraction filter or a diffusion filter. A diffraction filter includes micro louvers (e.g., a film of micro louvers) that diffract light thereby blocking an observer outside of the second viewing cone 180b from being able to view information displayed on a portion of the display 135 overlaid by the diffraction filter. A diffusion filter sufficiently blurs the image of the display 135 by diffusing light so that an observer outside of the second narrow viewing cone 180b is typically unable to discern text or other information displayed on a portion of the display 135 overlaid by the diffusion filter. That said, any privacy filter capable of providing a narrow viewing cone is within the scope of the present invention. In a particular embodiment, the privacy filter 137 is mechanically positioned over a portion of the display 135 after a user initiates an ATM session and is retracted from the display 135 once the ATM session has terminated.

In yet another embodiment depicted in FIG. 3B, the display 135 may be a dual layered display, where the display includes an outer first display layer 135a and an inner second display layer 135b. In other words, in this embodiment the first display layer 135a is typically positioned between the observer 200 and the second display layer 135b. The first display layer 135a typically has a wide viewing cone as depicted in FIG. 2. FIG. 3B further depicts a privacy filter 137 positioned between the first display layer 135a and the second display layer 135b. Because the privacy filter 137 is positioned over the second display layer 135b, the privacy filter provides a narrow viewing cone for information displayed on the second display layer 135b. Because the first display layer 135a is positioned between the observer 200 and the second display layer 135b in this embodiment, at least part of the first display layer 135a is typically capable of being sufficiently transparent or translucent to allow the observer 200 to discern information (e.g., text or images) displayed on the second display layer 135b. For example, the first display layer 135a may be an organic light emitting diode (OLED) display or a liquid-crystal display (LCD) that is capable of being sufficiently transparent. That said, it is within the scope of the present invention for the first display layer 135a to employ any display technology (e.g., electrophoretic ink) that is capable of being sufficiently transparent or translucent to allow the observer 200 to discern information (e.g., text or images) displayed on the second display layer 135b.

Returning to the components of the ATM 100, as used herein, a “memory” device (e.g., the memory 140) generally refers to a device or combination of devices that store one or more forms of computer-readable media for storing data and/or computer-executable program code/instructions. Computer-readable media is defined in greater detail below. For example, in one embodiment, the memory 140 includes any computer memory that provides an actual or virtual space to temporarily or permanently store data and/or commands provided to the processor 120 when it carries out its functions described herein.

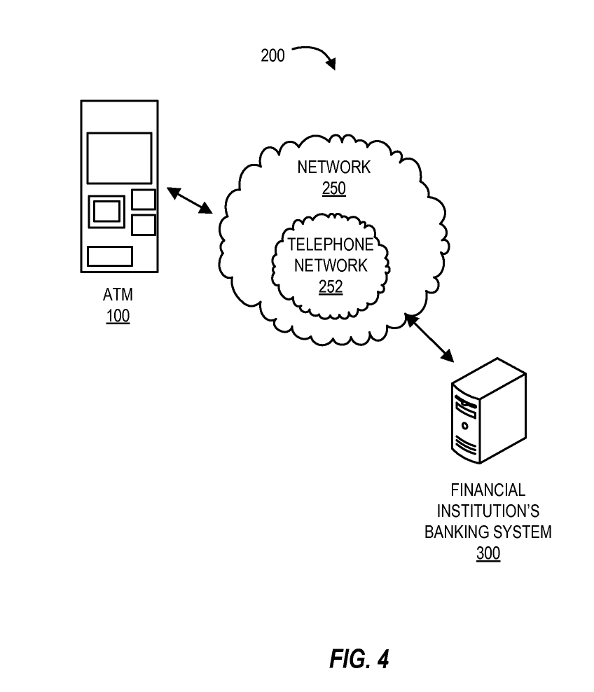

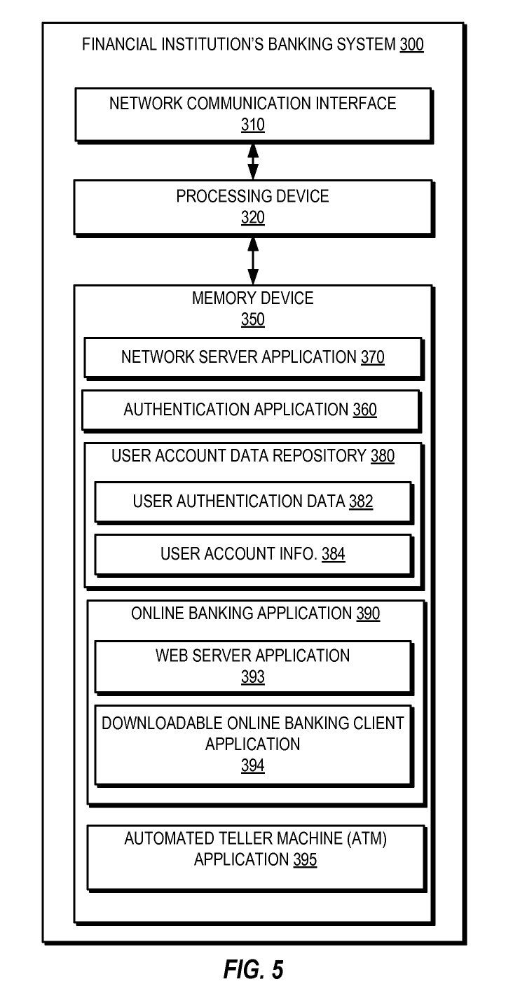

As further illustrated in FIG. 1, the memory 140 may include an ATM application 144. It will be understood that the ATM application 144 can be executable to initiate, perform, complete, and/or facilitate one or more portions of any embodiment described and/or contemplated herein. Generally, the ATM application 144 is executable to receive transaction instructions from the user and initiate, perform, complete, and/or facilitate any transaction described and/or contemplated herein, including perform typical ATM functions, as appreciated by those skilled in the art. The ATM application 144 may be configured to interact (e.g., communicate) with one or more external systems (e.g., a banking system as described with respect to FIGS. 4-5) in order to facilitate (e.g., initiate, perform, and/or complete,) one or more transactions (e.g., viewing an account balance, withdrawing funds, transferring funds, or making a deposit). In typical embodiments, the ATM application is configured to access and display content (e.g., via the display 135), such as data stored in memory 140, for example in the ATM datastore 142, or a database in communication with the ATM 100 (e.g., a banking system as described with respect to FIGS. 4-5). In some embodiments, the ATM 100 may transfer the content to an external device (e.g., a mobile device) if the external device is configured for contactless communication. The content may include coupons, ads, offers, images, financial receipts, account-related documentation, reissued account card, new account card, prepaid cards, or the like.

As noted, the ATM application 144 is also typically configured to implement a privacy protocol that may be stored in the memory 140. The ATM application 144 is typically configured to initiate the privacy protocol once a user an initiated an ATM session and to terminate the privacy protocol once the ATM session has ended. In some embodiments, initiating the privacy protocol may be further based user input. For example, the ATM 100 may include a button that enables a user engaged in an ATM session to enable or disable the privacy protocol.

Once enabled, the privacy protocol reduces the viewability of at least a portion of the display 135 as described herein. For example, the ATM application 144 may alter display characteristics of a portion of the display 135 thereby resulting in a portion of the display 135 having a narrow viewing cone. If the display includes an outer display layer having a wide viewing cone and an inner display layer having a narrow viewing cone as depicted in FIG. 3B, the ATM may display some information using the inner display layer.

Before the privacy protocol is implemented, the ATM application 144 is typically configured to display non-private information on the display 135. Such non-private information may be any information that the financial institution operating the ATM 100 may wish to publicly display or disclose (i.e., public information). Non-private information may include advertisements (e.g., advertisements from the financial institution or from third parties), welcome information, information regarding the financial institution's locations, information regarding the financial institution's contact information, information regarding the financial institution's products and services, or other public information regarding the financial institution. Once the privacy protocol has been implemented, private information may be displayed on the display (e.g., on a portion of the display having reduced viewability). Such private information is typically any information that the financial institution only wishes to be discerned by users of the ATM. Private information is typically user-specific information (i.e., information specific to a user of an ATM). Accordingly, private information typically includes user-specific information regarding the user's accounts (e.g., account number, account balance, account transaction information, account login information, and the like). Private information may also include user-specific communications between the financial institution and the user, such as messages, receipts, and/or user-specific advertisements or offers. Non-private information may also be displayed on any portion of the display having reduced viewability. The financial institution typically defines whether certain information is private or public. That said, in some embodiments users may have the ability to specify whether certain types of information are public or private.

In some embodiments, the viewability of the entire display 135 may be reduced. That said, in other embodiments the viewabilty of only a portion of the display 135 is reduced once the privacy protocol is implemented. Accordingly, the display 135 may concurrently display (i) private information on the portion having reduced viewability and (ii) public information on the remainder of the display 135. If the display 135 includes inner and outer display layers as depicted in FIG. 3B, non-private information may be displayed on the outer display layer, and private information may be displayed on the inner display layer. In addition, the ATM application 144 is typically configured to alter images (e.g., information) displayed by the first display layer 135a so that information displayed on the second display layer 135b can be discerned by a user of the ATM 100. In other words, images on the first display layer 135a that would otherwise obstruct information displayed on the second display layer 135b are typically removed or altered when the second display layer 135b displays information so that such information displayed on the second display layer 135b can be discerned. That said, it is within the scope of the present invention for images displayed on the first display layer 135a to overlay information concurrently displayed on the second display layer 135b, provided that the information displayed on the second display layer 135b is not obstructed (i.e., can still be discerned by a user of the ATM 100).

The ATM 100 typically requires users to identify and/or authenticate themselves to the ATM 100 before the ATM 100 will initiate, perform, complete, and/or facilitate a transaction. For example, in some embodiments, the ATM 100 is configured (and/or the ATM application 144 is executable) to authenticate an ATM user based at least partially on an ATM debit card, smart card, token (e.g., USB token, etc.), username, password, personal identification number (PIN), biometric information, and/or one or more other credentials that the user presents to the ATM 100. Additionally or alternatively, in some embodiments, the ATM 100 is configured to authenticate a user by using one-, two-, or multi-factor authentication. For example, in some embodiments, the ATM 100 requires two-factor authentication, such that the user must provide a valid debit card and enter the correct PIN associated with the debit card in order to authenticate the user to the ATM 100. Alternatively, the user may be able to provide his or her online banking username and password for authentication. The ATM application 144 may be configured to interact with one or more external systems (e.g., a banking system as described with respect to FIGS. 4-5) in order to facilitate user authentication.

FIG. 4 provides a block diagram illustrating an environment 200 in which the ATM 100 is in communication with a banking system 300 and environment 200. The ATM 100 is typically configured to communicate over a network 250 with a financial institution's banking system 300. The financial institution's banking system 300 is described in greater detail below with reference to FIG. 5. The network 250 may include a local area network (LAN), a wide area network (WAN), and/or a global area network (GAN). The network 250 may provide for wireline, wireless, or a combination of wireline and wireless communication between devices in the network. In one embodiment, the network 250 includes the Internet. In one embodiment, the network 250 includes a telephone network 252.

In general, ATM 100 is configured to connect with the network 250 to log the user into the banking system 300. The banking system 300 involves authentication of the user in order to access the user's account on the banking system 300. For example, the banking system 300 is a system where the user logs into his/her account such that the user can access data that is associated with the user. For example, in one embodiment of the invention, the system 300 may allow the user to access his or her account via the ATM 100. Logging into the banking system 300 generally requires that the user authenticate his/her identity using a user name, a passcode, a cookie, a biometric identifier, a PIN, a private key, a token, and/or another authentication mechanism that is provided by the user to the banking system 300 via the ATM 100. Once the user has been successfully logged into the banking system 300, the user may be permitted to complete one or more transactions involving the user's account(s) via the ATM 100.

The financial institution's banking system 300 is typically in network communication with other devices. In one embodiment, an application download server may be used to download online and/or mobile banking software applications that interact with the banking system 300. In some embodiments of the invention, the application download server is configured to be controlled and managed by one or more third-party data providers (not shown in FIG. 4) over the network 250. In other embodiments, the application download server is configured to be controlled and managed over the network 250 by the same entity that maintains the banking system 300.

FIG. 5 provides a block diagram illustrating the banking system 300 in greater detail, in accordance with an embodiment of the invention. As illustrated in FIG. 5, in one embodiment of the invention, the banking system 300 includes a processing device 320 operatively coupled to a network communication interface 310 and a memory device 350. In certain embodiments, the banking system 300 is operated by a financial institution, while in other embodiments, the banking system 300 is operated by an entity other than a financial institution.

It should be understood that the memory device 350 may include one or more databases or other data structures/repositories. The memory device 350 also includes computer-executable program code that instructs the processing device 320 to operate the network communication interface 310 to perform certain communication functions of the banking system 300 described herein. For example, in one embodiment of the banking system 300, the memory device 350 includes, but is not limited to, a network server application 370, an authentication application 360, a user account data repository 380 which includes user authentication data 382 and user account information 384, an online banking application 390 which includes a web server application 393, a downloadable online banking client application 394, an automated teller machine (ATM) application 395, and other computer-executable instructions or other data. The computer-executable program code of the network server application 370, the authentication application 360, the online banking application 390, or the automated teller machine (ATM) application 395 may instruct the processing device 320 to perform certain logic, data-processing, and data-storing functions of the banking system 300 described herein, as well as communication functions of the banking system 300. For example, the automated teller machine (ATM) application 395 is typically configured to interact with the ATM 100 so that the user can perform one or more transactions using the ATM 100 (e.g., transactions involving one or more of the user's accounts at the financial institution).

In one embodiment, the user account data repository 380 includes user authentication data 382 and user account information 384. The network server application 370, the authentication application 360, automated teller machine (ATM) application 395, and the online banking application 390 are configured to access user account information 384 and the user authentication data 382 (e.g., user identification information) when authenticating a user to the banking system 300. In this regard, the user authentication data 382 may include a user's username, password, and/or PIN number.

As used herein, a “communication interface” typically includes a modem, server, transceiver, and/or other device for communicating with other devices on a network, and/or a user interface for communicating with one or more users. Referring again to FIG. 5, the network communication interface 310 is a communication interface having one or more communication devices configured to communicate with one or more other devices on the network 250, such as the ATM 100. The processing device 320 is typically configured to use the network communication interface 310 to transmit and/or receive data and/or commands to and/or from the other devices connected to the network 250.

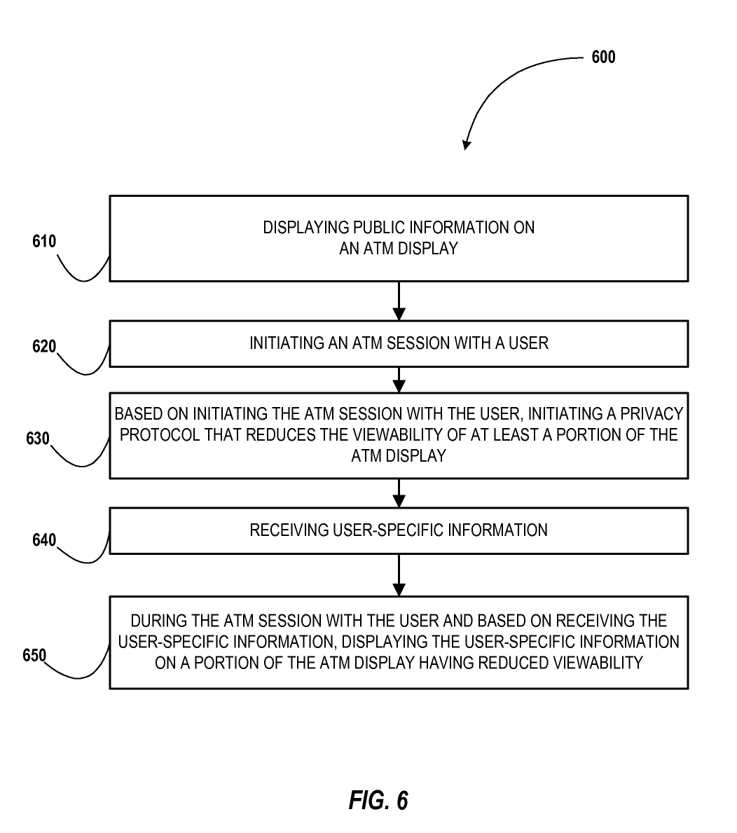

Referring now to FIG. 6, a general process flow 600 is provided for displaying information on a display of an ATM in accordance with an aspect of the present invention. As described herein, the ATM display may be capable of displaying information using a wide viewing cone or a narrow viewing cone.

At block 610, the method includes displaying public information on the ATM display. The public information may be any information that the financial institution operating the ATM wishes to display. For example, the public information may include one or more advertisements and/or information regarding a financial institution's locations, contact information, products, and/or services.

At block 620, an ATM session is initiated with a user. Before initiating the ATM session, the user is typically required to authenticate his or her identity. For example, the user may provide a debit or ATM card to the ATM (e.g., using a card reader), after which the ATM prompts the user to provide an associated PIN or other authentication information. This authentication information is then typically provided to a financial institution's banking system in communication with the ATM in order to verify the user's identity. Once the user's identity has been verified, the ATM session is typically initiated, after which the user may complete one or more transactions via the ATM.

Based on initiating the ATM session with the user, at block 630, the ATM initiates a privacy protocol that reduces the viewability of at least a portion of the ATM display. In some instances, the viewability of the entire ATM display may be reduced. In an exemplary embodiment, display characteristics of at least a portion of the ATM display may be altered to reduce the viewability of the altered portion of the ATM display. If the ATM display has an outer display layer having a wide viewing cone and an inner display layer having a narrow viewing cone, the privacy protocol may cause the ATM to display at least some information using the inner display layer.

During the ATM session, at block 640, the ATM receives user-specific or other private information. The user-specific information may include user account information (e.g., an account number, account balance, account statement, account-related documentation, and/or the like), a user-specific message (e.g., a message between the user and the financial institution regarding the user's account), and/or a user-specific advertisement and/or offer. This user-specific information may be received from the user, the financial institution's banking system, and/or the ATM's memory. For example, once the ATM session has been initiated, the ATM may receive information regarding the user's account(s) from the financial institution's banking system.

At block 650, based on receiving user-specific information, the ATM displays the user-specific information on the portion of the ATM display having reduced viewability (e.g., having a narrow viewing cone). By displaying user-specific information on the portion of the ATM display having reduced viewability, individuals other than the user can be prevented from discerning such user-specific information.

During the ATM session, public information may be displayed on the ATM display (e.g., on a portion of the ATM display having reduced viewability or on a portion of the ATM display not having reduced viewability) at the same time user-specific information is displayed on a portion of the ATM display having reduced viewability. For example, advertisements or financial institution information may be displayed on an outer display layer having a wide viewing cone at the same time user account information is displayed on an inner display layer having a narrow viewing cone. If the ATM display has inner and outer display layers, then the ATM may alter images displayed on the outer display layer so that information displayed on the inner display layer can be discerned by the user.

Subsequently, after the user has completed one or more transactions using the ATM, the ATM session is terminated. Thereafter, any user-specific information is typically removed from the ATM display.

Method for Providing Privacy Through ATM Communication to Consumer Devices

In another aspect, the present invention generally relates to an automated teller machine (ATM) having the ability to privately communicate with a user device and/or initiate the communication of information to a user device using one or more private methods. For example, the ATM may associate a user device, such as a mobile device (e.g., a smartphone or tablet computer), with a currently initiated ATM session. In response to processing a user request during the ATM session, the ATM may then either initiate a call with the user directly, initiate a private messaging conversation, or transmit email or text information to the user's device.

### Environment and Hardware Description

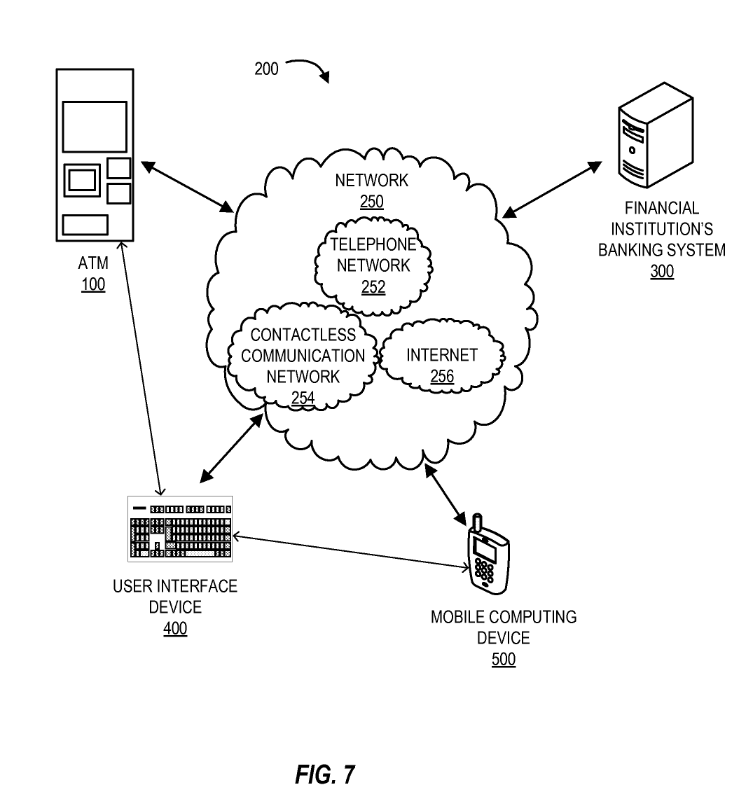

FIGS. 7, 8, and 9 depict the operating environment, user interface, and mobile device used in the current invention. Accordingly, FIG. 7 provides a block diagram illustrating a modified environment 200 in which the ATM 100 is in communication with a banking system 300 and environment 200, as previously discussed herein, and in further communication with a user interface device 400 and/or a user's mobile computing device 500 (i.e., a user's mobile device) according to additional embodiments of the present invention discussed hereinafter.

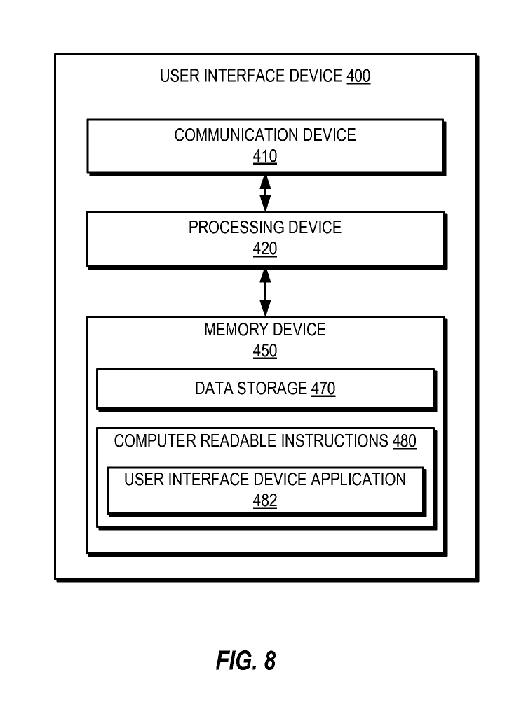

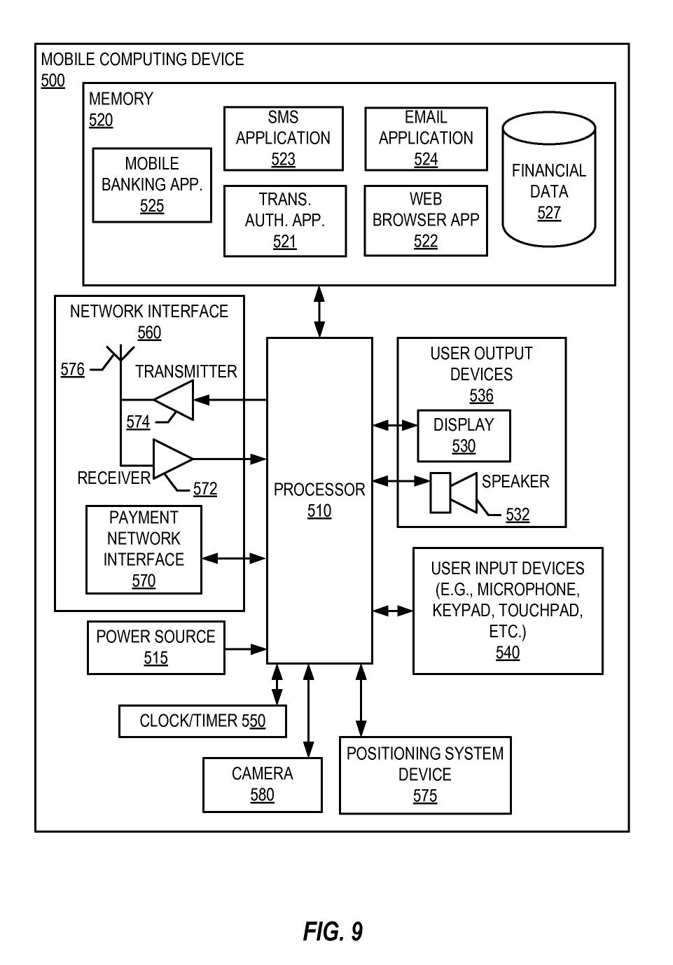

The ATM 100, banking system 300, user interface device 400, and mobile computing device 500 are each configured to communicate with each other over a network 250. The ATM 100 and banking system 300 are each described in greater detail above with reference to FIG. 1 and FIG. 5, respectively. The user interface device 400 and mobile computing device 500 are each described in greater detail below with reference to FIGS. 8-9.

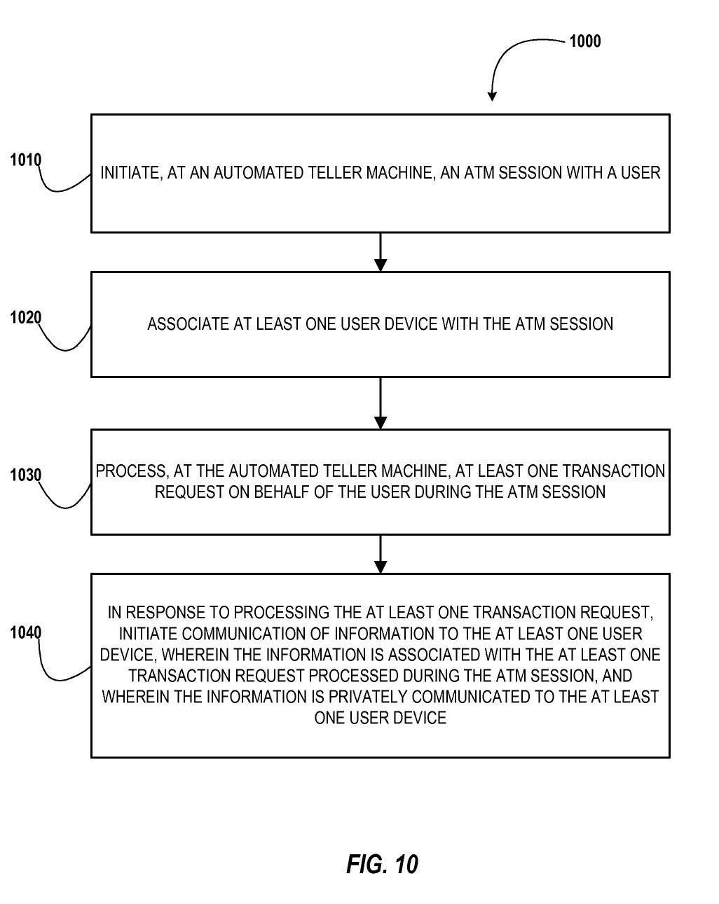

Referring to FIG. 7, the network 250 may include a local area network (LAN), a wide area network (WAN), a global area network (GAN), near field communication network, Bluetooth network, WI-FI, cellular, or any other type of communications network or protocol. In the depicted embodiment, the network 250 comprises a telephone network 252, contactless communication network 254 (e.g., a network employing a contactless communication technology, such as near field communication (NFC), Bluetooth®, radio frequency identification (RFID), IR, and/or the like), and the Internet 256. In some embodiments of the invention, the mobile computing device 500 communicates with the ATM 100 over the contactless communication network 254. For example, the mobile computing device 500 may communicate with the ATM 100 when the user associates the mobile computing device 500 with the ATM session, as described in relation to block 1020 of FIG. 10, and/or when mobile computing device 500 otherwise sends and/or receives information to/from the ATM 100. In some embodiments, the mobile computing device 500 communicates with the banking system 300 via telephone network 252 or the internet 256.

In some embodiments, ATM 100 communicates with the user interface device 400 via the contactless communication network 254. For example, ATM 100 may communicate with the user interface device 400 when the user associates the user interface device 400 with the ATM session, as described in relation to block 1020 of FIG. 10, and/or when the ATM otherwise receives information from the user interface device 400. In some embodiments, the ATM 100 may have a specific device such as a touch pad that contains a contactless communication chip and serves as a specific location that a user may place a corresponding interface device for the purpose of sending and/or receiving information from the ATM 100. In this regard, the user may have a preexisting authentication token stored on his or her user interface device such that when contacting the touch pad containing the contactless communication chip, authentication information is transmitted from the user interface device to the automated teller machine, and the user's identity is subsequently authenticated upon receipt of the information.

The user interface device 400 may be any device capable of communicating information (e.g., transmitting or receiving information) between a user and the ATM 100. Accordingly, the user interface device 400 may be a keyboard, touch screen display, microphone, video camera, and the like. In this way, the user interface device 400 may be directly integrated with the ATM 100 or a separate device of the user and configured to interact with the ATM 100. As such, in some embodiments, the user interface device 400 and the mobile computing device 500 may be the same device. For example, a keyboard or touch pad integrated within the mobile computing device 500 may be used as the user interface device 400 in communication with the ATM 100.

As illustrated in FIG. 8, the user interface device 400 may include a communication device 410, a processing device 420, and a memory device 450. The processing device 420 is operatively coupled to the communication device 430 and the memory device 450 having data storage 470 therein. In some embodiments, the processing device 420 may send or receive data from the user's interface device 400, to the ATM 100 via the communication device 430 over a network 250. As such, the communication device 430 generally comprises a modem, server, or other device for communicating with other devices on the network 250.

As further illustrated in FIG. 8, the user interface device 400 typically includes computer readable instructions 480 stored in the memory device 450, which in one embodiment includes the computer-readable instructions 480 of an application 482. In the embodiment illustrated in FIG. 7, the application 482 may allow the user interface device 400 to be linked to the ATM 100 via a network 250. The application 482 may also allow the user's interface device 400 to connect directly (e.g., locally or device to device) with the ATM 100 for sending and receiving information. The application 482 may perform one or more of the steps and/or sub-steps discussed herein and/or one or more steps not discussed herein. For example, in some embodiments, the application 482 may receive information to be presented on a display within or in communication with the user interface device 400. It should be noted that although the ATM 100 and the user interface device 400 are illustrated as separate component having independent circuitry and/or applications, in an exemplary embodiment, the ATM 100 and the user interface device 400 are integrated with one another such that they share circuitry components and applications.

Referring now to FIG. 9, the mobile computing device 500 associated with the user and embodied as a user device is described. FIG. 9 provides a block diagram illustrating mobile computing device 500 in accordance with embodiments of the invention. In one embodiment of the invention, the mobile computing device 500 is a mobile telephone. However, it should be understood, however, that a mobile telephone is merely illustrative of one type of mobile computing device 500 that may benefit from, employ, or otherwise be involved with embodiments of the present invention and, therefore, should not be taken to limit the scope of embodiments of the present invention. Other types of mobile user computing devices 500 may include portable digital assistants (PDAs), pagers, mobile televisions, gaming devices, laptop computers, cameras, video recorders, audio/video player, radio, GPS devices, or any combination of the aforementioned.

The mobile computing device 500 generally includes a processor 510 communicably coupled to such devices as a memory 520, user output devices 536, user input devices 540, a network interface 560, a power source 515, a clock or other timer 550, a camera 580, and a positioning system device 575. The processor 510 generally includes circuitry for implementing communication and/or logic functions of the mobile computing device 500. The processor 510 can additionally include an internal data modem. Further, the processor 510 may include functionality to operate one or more software programs, which may be stored in the memory 520. For example, the processor 510 may be capable of operating a connectivity program, such as a web browser application 522. The web browser application 522 may then allow the mobile computing device 500 to transmit and receive web content, such as, for example, location-based content and/or other web page content, according to a Wireless Application Protocol (WAP), Hypertext Transfer Protocol (HTTP), and/or the like.

The processor 510 is configured to use the network interface 560 to communicate with one or more other devices on the network 450. In this regard, the network interface 560 includes an antenna 576 operatively coupled to a transmitter 574 and a receiver 572 (together a “transceiver”). The processor 510 is configured to provide signals to and receive signals from the transmitter 574 and receiver 572, respectively. In some embodiments where network 350 is a wireless telephone network, the signals may include signaling information in accordance with the air interface standard of the applicable cellular system of the wireless telephone network. In this regard, the mobile computing device 500 may be configured to operate with one or more air interface standards, communication protocols, modulation types, and access types. By way of illustration, the mobile computing device 500 may be configured to operate in accordance with any of a number of first, second, third, and/or fourth-generation communication protocols and/or the like. For example, the mobile computing device 500 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile computing device 500 may also be configured to operate in accordance with non-cellular communication mechanisms, such as via a wireless local area network (WLAN), near field communication network, or other communication/data networks.

The network interface 560 may also include a payment network interface 570. The payment network interface 570 may include software, such as encryption software, and hardware, such as a modem, for communicating information to and/or from one or more devices on a network. For example, the mobile computing device 500 may be configured so that it can be used as a credit or debit card by, for example, wirelessly communicating account numbers or other authentication information to the automated teller machine 100.

As described above, the mobile computing device 500 has a user interface that is, like other user interfaces described herein, made up of user output devices 536 and/or user input devices 540. The user output devices 536 include a display 530 (e.g., a liquid crystal display or the like) and a speaker 532 or other audio device, which are operatively coupled to the processor 510. The user input devices 540, which allow the mobile computing device 500 to receive data from a user, may include any of a number of devices allowing the mobile computing device 500 to receive data from a user, such as a keypad, keyboard, touch-screen, touchpad, microphone, mouse, joystick, other pointer device, button, soft key, and/or other input device(s). The user interface may also include a camera 580, such as a digital camera.

The mobile computing device 500 may also include a positioning system device 575 that is configured to be used by a positioning system to determine a location of the mobile computing device 500. For example, the positioning system device 575 may include a GPS transceiver. In some embodiments, the positioning system device 575 is at least partially made up of the antenna 576, transmitter 574, and receiver 572 described above. For example, in one embodiment, triangulation of cellular signals may be used to identify the approximate location of the mobile computing device 500. In other embodiments, the positioning system device 575 includes a proximity sensor or transmitter, such as an RFID tag, that can sense or be sensed by devices known to be located proximate a merchant or other location to determine that the consumer mobile computing device 500 is located proximate these known devices.

The mobile computing device 500 further includes a power source 515, such as a battery, for powering various circuits and other devices that are used to operate the mobile computing device 500. Embodiments of the mobile computing device 500 may also include a clock or other timer 550 configured to determine and, in some cases, communicate actual or relative time to the processor 510 or one or more other devices.

The mobile computing device 500 also includes a memory 520 operatively coupled to the processor 510. As used herein, memory includes any computer readable medium (as defined herein below) configured to store data, code, or other information. The memory 420 may include volatile memory, such as volatile Random Access Memory (RAM) including a cache area for the temporary storage of data. The memory 520 may also include non-volatile memory, which can be embedded and/or may be removable. The non-volatile memory can additionally or alternatively include an electrically erasable programmable read-only memory (EEPROM), flash memory or the like.

The memory 520 can store any of a number of applications which comprise computer-executable instructions/code executed by the processor 510 to implement the functions of the mobile computing device 500 described herein. For example, the memory 520 may include such applications as a transaction authentication application 521, conventional web browser application 522, a SMS application 523, and email application 524 and/or mobile banking application 525. In some embodiments, the mobile banking application 525 (or other application) may be used to facilitate an interactive session between the ATM 100 and the mobile computing device 500. These applications also typically provide a graphical user interface (GUI) on the display 530 that allows user 402 to communicate with other device within the system. In some embodiments, memory 520 may store financial data 527. Financial data 527 may include data or information relating to transactions of a user, such as credit card information, debit card information, bank account information, and/or information necessary to validate transactions involving the user. In some embodiments, financial data 527 may include the stored information that will be compared to user's inputted received user input to determine if a transaction should be authenticated.

The memory 520 can also store any of a number of pieces of information, and data, used by the mobile computing device 500 and the applications and devices that make up the mobile computing device 500 or are in communication with the mobile computing device 500 to implement the functions of the mobile computing device 500 and/or the other systems described herein. For example, the memory 520 may include stored data that may be used to verify a user's authentication data, etc. to complete a transaction.

### Description of Operation

As noted, the automated teller machine 100 may privately communicate with one or more user devices, such as the user interface device 400 and/or the mobile computing device 500. In this regard, FIG. 10 depicts a general process flow 1000 for providing privacy through automated teller machine (ATM) communication with consumer devices (e.g., mobile devices) in accordance with embodiments of the present invention. In some embodiments, the process flow 1000 is performed by a system (e.g., one or more apparatuses such as the ATM 100 and the banking system 300) having hardware and/or software configured to perform one or more portions of the process flow 1000. In such embodiments, as represented by block 1010, the system is configured to initiate an ATM session with a user at an automated teller machine. As represented by block 1020, the system is also configured to associate at least one user device (e.g., a mobile device) with the ATM session. As represented by block 1030, the system is configured to process at least one transaction on behalf of the user during the ATM session. Lastly, as represented by block 1040, the system is also configured to initiate communication of information to the at least one user device in response to processing the at least one transaction request.

It will be understood that the system having the process flow 1000 can include one or more separate and/or different apparatuses. For example, in some embodiments of the invention, a single apparatus (e.g., automated teller machine 100 described in connection with FIG. 4 and FIG. 7) is configured to perform all of the portions of process flow 1000 represented by blocks 1010 to 1040. However, in some other embodiments, a first apparatus (e.g., the automated teller machine 100 described in connection with FIG. 4 and FIG. 7) is configured to perform the portions of process flow 1000 represented by blocks 1010 and 1020, and a second apparatus (e.g., financial institution computer system 300 described in connection with FIG. 4 and FIG. 7) is configured to perform the portions of process flow 1000 represented by block and 1030 and 1040.

Regarding block 1010, the system may first initiate an ATM session with the user at the automated teller machine. In an exemplary embodiment, the automated teller machine is maintained by an entity such as a financial institution and the user has at least one account with the financial institution. As such, prior to receiving any user transaction request, the user may be first required to initiate an ATM session with the automated teller machine such that the user is able to process financial transactions. In some embodiments, initiating an ATM session with the user at the ATM may further comprise first authenticating the user's identity. In an exemplary embodiment, the authentication is based at least partially on user input or authentication credentials that verify that user is an account holder of the financial institution. For example, the user may insert an ATM card, within the ATM, that is associated with at least one of the user's accounts and additionally enter a personal identification number (PIN) associated with the ATM such that the user's identity is subsequently verified. Subsequent information related to the initiated ATM session is similarly associated with the user's account. In some embodiments, the user input or authentication credentials may be received from a user interface device (e.g., the mobile computing device 500) via an established network connection as opposed to being through an interface device integrated with the automated teller machine. The user input may include one or more authentication credentials associated with the user. The requested and/or received authentication credentials may vary based on the type of ATM session being initiated. In this way, numerous types and levels of user authentication may exist, and the user may be initially authenticated for a primary level of access to conduct general transactions within the ATM session, and the user may be required to provide a subsequent stricter authentication in an instance where a need exist to conduct a transaction that is not provided within the primary level of access received. In some embodiments, the received authentication credentials may be used by the automated teller machine to prepare information for communication to one or more user devices. User authentication credentials may include, but not be limited to, account cards, account personal identification (PIN) numbers, a username, password, account number, full-length social security number or partial digits, challenge questions, familiar pictures and/or phrases, biometrics, key fob-based alphanumeric codes, and the like.

Regarding block 1020, after initiating an ATM session with the user, the system may then associate at least one user interface device with the initiated ATM session. In an exemplary embodiment, the user interface device is embodied by a mobile computing device, as illustrated in FIG. 7. However, it should be noted that the user interface device may be embodied by other devices not contemplated herein. In some embodiments, associating a user device (e.g., a user interface device) with the initiated ATM session comprises receiving contact information associated with and/or related to the user device such that in an instance that the automated teller machine is required to privately communicate information to the user during the initiated ATM session, the automated teller machine may have a means for transmitting such information to the device of the user. The contact information may be received from the user in real-time during the ATM session or received based on information previously provided by the user (e.g., user contact preferences for private communication at an ATM). As such the contact information may include, but is not limited to, a mobile phone number associated with a mobile device of the user, an email address associated with an email account being maintained on the at least one user device, and the like. In this way, the system may subsequently communicate information to the user via phone call, email, text message, multimedia messaging, and the like.

Further concerning block 1020, in some embodiments, associating the at least one user interface device with the initiated ATM session includes establishing a network connection (e.g., via the Internet, a telephone network, or contactless communication) between the automated teller machine and the at least one user interface device. In some embodiments, the established network connection between the automated teller machine and the at least one user interface device additionally facilitates an interactive session between the automated teller machine and the user interface device. Through the interactive session, the automated teller machine is configured to send and receive data to and from the user interface device, and the user interface device is configured to send and receive data to and from the automated teller machine. This interactive session may be facilitated by an application on the user interface device (e.g., a mobile banking application downloaded on a mobile device). In some embodiments, information is sent from the automated teller machine and received at the user interface device in response to the automated teller machine processing at least one transaction request from the user. For example, the user may request that information associated with the ATM session be privately communicated from the automated teller machine such that the user receives a call on his or her user interface device (e.g., mobile phone) from personnel associated with the entity responsible for maintain the automated teller machine. In some embodiments, information is sent from the automated teller machine and received at the user interface in response to the user interface device sending a request for specific information/data. For example, the user may use his or her mobile device to send a request for a transaction statement to be received from the automated teller machine. In response to the request, the automated teller machine may then communicate the requested transaction statement to the user's mobile device. The requested information may additionally be sent automatically based on other factors presented within the ATM session without a need for external input from either the user. In other embodiments, information may be exchanged between the automated teller machine the user interface on a continuous and/or semi-continuous basis. In some embodiments, the user may employ the user interface device to perform ATM transactions during an interactive session. For example, the user may use a mobile device to initiate or complete an ATM transaction (e.g., withdraw or transfer funds) at the ATM instead of directly interacting with the ATM. In a further embodiment, a user may queue ATM transactions using the user interface device before initiating an interactive session between the ATM and the user interface device.

In an exemplary embodiment, the established network connection is a secured network connection, and the user's identity is authenticated prior to establishing a secured network connection. In such an embodiment, the system may first establish a general and/or unsecured network connection with the mobile device solely for the purpose of authenticating the user's identity prior to initiating the ATM session with the user. Information transmitted through the unsecured network connection, such as sensitive user information maintained within user authentication credentials, may be required to be encrypted prior to being sent from the user device to the system. As such the user device may separately send a decryption key to the automated teller machine. After the user has been authenticated and the user's identity has been subsequently verified, the system may then establish a secure network connection between the automated teller machine and the user device such that private information (e.g., user financial data) may be transmitted through the secured without requiring encryption prior to being sent.

Regarding block 1030, the system may process at least one transaction request one behalf of the user during the ATM session. The transaction request may be process before or after associating at least one user device with the ATM session. In some embodiments, the at least one transaction request is related to traditional banking and/or financial institution transactions associated with the user's financial institution account such as cash withdrawals, cash deposits, check deposits, monetary transfers between a plurality of accounts associated with the ATM session, payment request, and/or setting one or more user preferences for either the current or a future ATM session. For example, in one embodiment, the transaction request may include a request for the automated teller machine to privately communicate information associated with the ATM session to the user (e.g., by initiating an interactive session between the ATM 100 and the user interface device 400 or mobile computing device 500).

Information related to the transaction request may be received from the user via an input device integrated with the automated teller machine. For example, in some embodiments the automated teller machine display is a touch screen display that allows the user to not only view transaction request options but directly interact with the display to select a transaction request option and to execute additional actions. In an instance that the display is not a touch screen display, the user may interact with the automated teller machine using a plurality of other devices or features integrated within the automated teller machine (e.g., keyboard, voice recognition, and the like).

In some instances, information related to the transaction request may be received from a user interface device (e.g., a mobile computing device) enabled in response to associating the interface user device with the ATM session. Enabling a user interface device may include activating one or more interface device for use by the ATM. For example, a QWERTY keyboard integrated with the ATM may be dormant and/or inactive such that the user does not have access to the device and/or the system does not receive information from the device prior to the device being enabled.

Regarding block 1040, in response to processing the at least one transaction request on behalf of the user, the system may then initiate the communication of information to the at least one user device, where the information is privately communicated to the at least one user device. In this way, information may be communicated to the user via one or more private methods of communication including, but not limited to, phone calls, private instant messaging, email messaging, text messaging, multimedia messaging, direct transmission of information via a two-way network connection, and the like. The communicated information may be associated with and/or related to the at least on transaction request. As used herein the phrase “initiate communication” refers to the system causing a process and/or action to commence the communication of information to the at least one user device, and subsequently communicate the information to the at least one user device.

The private method of communication may be an interactive session between the ATM and the user interface device (e.g., user mobile computing device). During the interactive session, the user interface device may receive information from the ATM, provide information to the ATM, and/or initiate or complete one or more additional ATM transactions. During the interactive session, the ATM session is typically maintained and not terminated. Accordingly, the user can concurrently interact with the ATM both directly via the ATM itself and indirectly via the user interface device.

In a particular embodiment, the private method of communication is embodied by a phone call session between the user and personnel and/or an interactive voice response system associated with the entity responsible for maintaining the automated teller machine. In such an embodiment, initiating communication of information to the user device comprises sending a request from the automated teller machine to personnel or an interactive voice response system associated with the entity responsible for maintaining the automated teller machine, where the request indicate that a phone call should be initiated with the at least one user interface device based on the contact information provided when associating the at least one user device with the ATM session. For example, a user with a sight impairment may submit a transaction request for information associated with the ATM session to be privately communicated from the automated teller machine to the at least one user interface device, the request in addition to the user's telephone number may then be transmitted to personnel associated with the entity responsible for maintaining the automated teller machine such that the personnel subsequently calls the user's mobile device and interacts with the user during the ATM session.

In another particular embodiment, the private method of communication is embodied by a private instant messaging session between the user and personnel or an automated agent associated with the entity responsible for maintaining the automated teller machine. In such an embodiment, initiating private communication of information to the user includes providing an instant messaging window and enabling a user interface device for the purpose of facilitating the private instant messaging session between the user and personnel or automated agent associated with the entity responsible for maintaining the automated teller machine, where the instant messaging window may be displayed directly on a display integrated within the automated teller machine or displayed on a display associated with a separate user device (e.g., a mobile device). For example, a user may submit a transaction request to initiate an instant messaging session during the ATM session, in response the transaction request the system may display an instant messaging window on a display integrated within the automated teller machine and enable a keyboard integrated with the automated teller machine to receive user input from the user. In another example, a user may submit a transaction request to initiate an instant messaging session during the ATM session, in response the transaction request the system may display an instant messaging window on a display associated with a user device through a mobile banking application or website associated with the user device. In some embodiments, the instant messaging session may be facilitated using a combination of devices associated with both the automated teller machine and a separate user device. For example, the instant messaging window may be displayed directly on a display integrated within the automated teller machine and user input may be received from a user input device associated with the user's mobile phone. During the instant messaging session, the user interface device may receive information from the ATM, provide information to the ATM, and/or initiate or complete one or more additional ATM transactions.

In some embodiments, the user interface device is configured to interact with the automated teller machine through an application associated with the automated teller machine and typically providing a graphical user interface (GUI). Through the application the user may be able to interact with the automated teller machine either based on broadcasted touch-pad/display prompts, voice commands, or another means. In one embodiment, the application is temporarily or permanently stored on the user interface device. For example, the application may be launched on the user interface device in response to a network connection being between the automated teller machine and the user interface device. In a particular embodiment, the application may be associated with a mobile banking application and manually launched on the user's mobile device after a establishing a network connection being between the automated teller machine and the mobile device. During an interactive session facilitated by the application, the user interface device may receive information from the ATM, provide information to the ATM, and/or initiate or complete one or more additional ATM transactions.

In some embodiments, the system may initiate communication of information to the at least one user interface device in response to a processing failure in processing the at least one transaction request. For example, the system may detect a processing failing while attempting to process a withdrawal transaction request due to unavailable funds, the system may then determine that a series of previous transactions associated with the user's account reflect trends that are typically associated with users who have been affected by a misappropriated identity. The system may then initiate the communication of information to the user interface device such that one or more forms (e.g., transaction dispute claims) are automatically transmitted to the at least one user interface device via email, text messaging, multimedia messaging, contactless communication, and the like.

In some embodiments, the user interface device is a printing device integrated within the automated teller machine. In such an embodiment, the automated teller machine may be configured to provide the user with information in a private manner by printing hard copies of documents discussed and/or presented electronically throughout the ATM session. The documents may include but not be limited to, transaction statements, receipts, call/ATM session logs, information pamphlets, and the like. For example, in alternative to electronically displaying information on the display of the automated teller machine where other individuals may be able to view the information, the system may instead print hard copies of the information to the user.

In some embodiments, the information communicated from the automated teller machine to the user may include a form of visual indicia. The visual indicia may be presented, for example, on a display integrated within the automated teller machine or printed, as previously discussed herein. The visual indicia may include, but not be limited to, a barcode, Quick Response (QR) code, hologram, and the like. In some embodiments, in response to the user scanning the visual indicia with his or her mobile device he/she may receive additional information that is related to the ATM session. For example, the user may be presented a QR code on a display within the automated teller machine and further instructed to scan the QR code using his or her mobile device. Upon scanning the QR code the user may be transmitted an electronic disclosure form, electronic information pamphlet, a payment token for use within a digital wallet, an electronic copy of the ATM session log, and/or the like. In some embodiments, the visual indicia may be used to leverage an existing user authentication or general check-in process within the automated teller machine. For example, the user may scan a QR code that is temporarily or permanently displayed within the automated teller machine when initially entering and prior to initiating the ATM session. In response to scanning the QR code, the automated teller machine may automatically obtain access to authentication credentials that are stored on the user's mobile device (e.g., within a mobile banking application), request the user provide authentication credentials, or a general description of his or her current purpose for the ATM session.

In some embodiments, the information communicated from the automated teller machine to the user may include an electronic payment credential. As used herein “token” (e.g., an alias, substitute, surrogate, or other like identifier) may refer to a replacement for sensitive account information, and in particular account numbers. As such, tokens or portions of tokens may be used as a stand in for a user account number, user name, pin number, routing information related to the financial institution associated with the account, security code, or other like information relating to the user account. The one or more tokens may then be utilized as a payment instrument to complete a transaction. The one or more tokens may be associated with one or more payment devices directly or within one or more digital wallets associated with the payment devices. In other embodiments, the tokens may be associated with electronic transactions that are made over the Internet instead of using a physical payment device. In one embodiment the electronic payment credential may be a token that the automated teller machine is configured to provision for use within a digital wallet maintained on the user's mobile device.

In some embodiments, the information communicated from the automated teller machine to the user may include one or more forms, transaction statements, or general documents associated with the ATM session. The forms may include, but not be limited to, account disclosures (e.g., savings account, checking accounts), transaction dispute forms, claims request and the like.

In some embodiments, the information communicated from the automated teller machine to the user may include a hyperlink. In such an embodiment, the hyperlink may be transferred directly to the user's mobile device. The hyperlink may reference documents presented during the ATM session, additional steps that the user should follow through with after the ATM session, and the like. The documents may be maintained on a website or server associated with the entity responsible for maintaining the automated teller machine and/or a third party. In some embodiments, the hyperlink is active for a predetermined period of time allowing the user to access the documents either for printing for his or her personal records, signing and returning to an appropriate entity, or general record of the documents.

In some embodiments, as previously discussed herein, in addition to transmitting data from the automated teller machine to the user, the automated teller machine is also configured to receive data directly from the user via the at least one user interface device. In an exemplary embodiment, the data is at least partially associated with the ATM session. To this extent, it should be noted that a user interface device in network communication with the ATM may similarly carry out any functions previously discussed herein with reference to data transmission using a device integrated within the automated teller machine, or vice versa.

In some embodiments, the information communicated from the automated teller machine to user device may include one or more digital images. The images may be associated with various file extensions configured to be maintained on the user's mobile device including, but not limited to, jpeg, tiff, raw, gif, bmp, png, and the like. For example, the user may receive an image file related to a receipt associated with the ATM session.

Method for Processing Transaction Statement Inquiries Via an ATM

In another aspect, the present invention relates to processing transaction statement inquiries via an ATM.

Traditionally, ATM users have had the ability to print miniature transaction statements during their ATM session while conducting other general financial transactions such as cash withdrawals, check deposits, and the like. That said, a need exists for improved ATM functionality.

Accordingly, embodiments of the invention are directed to systems, methods and computer program products for processing transaction statement inquiries via an ATM. The invention enables a user to provide at an ATM a request to view a transaction statement, wherein the ATM is maintained by a financial institution, and wherein the user has an account with the financial institution. The system may then present the transaction statement on a display associated with the ATM. A subsequent second request is received from the user, via the ATM, to select at least one line item within the transaction statement for inquiry processing. The system then processes at least one action for the at least one line item based at least partially on the second request from the user to select the at least one line item within the transaction statement for inquiry processing.

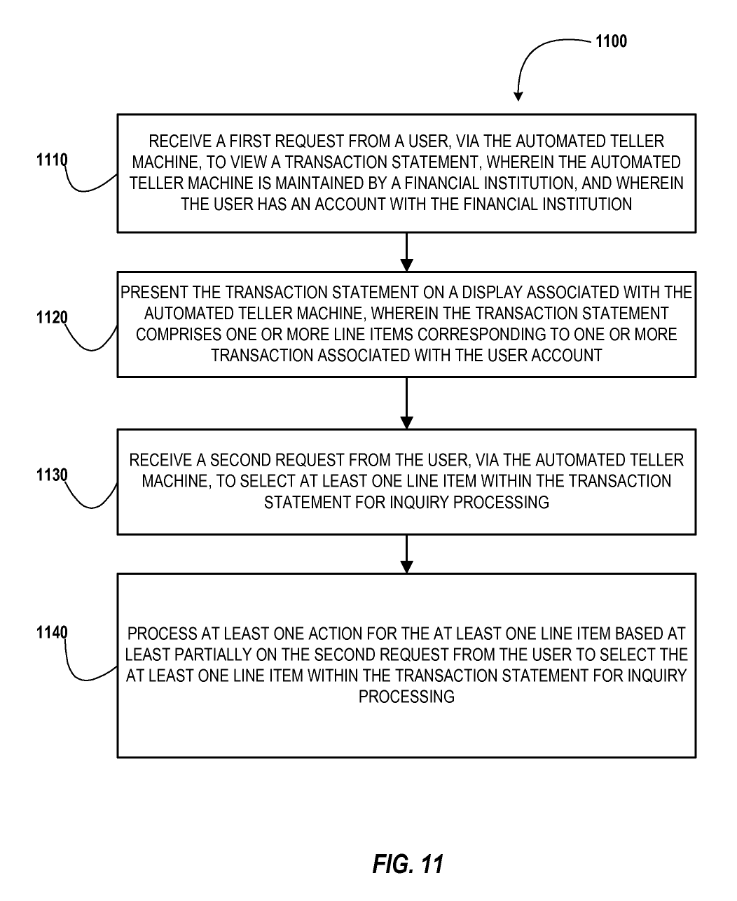

Referring now to FIG. 11, a high level process flow 1100 for processing transaction statement inquiries for users via an ATM is illustrated in accordance with one embodiment of the present invention, which will be discussed in further detail throughout this specification. As illustrated, the method may include a plurality of steps, including but not limited to, receiving a first request from a user to view a transaction statement, where the ATM is maintained by a financial institution and the user has an account with the financial institution at step 1110, presenting the transaction statement on a display associated with the ATM at step 1120, receiving a second request from the user to select at least one line item within the transaction statement for inquiry processing at step 1130, and processing at least one action for the at least one line item based at least partially on the second request from the user at step 1140.

As represented by step 1110, the system first receives a request from a user to view a transaction statement. The request is received from the user via an ATM. In an exemplary embodiment, the ATM is maintained by an entity such as a financial institution and the user has at least one account with the financial institution. As such, prior to receiving the request the user may be first required to initiate a session with the ATM where the user is able to process financial transactions utilizing the ATM. Initiating the ATM session may require the user to first authenticate his or her identity using various authentication method. For example, the user may insert an ATM card within the ATM that is associated with at least one of the user's accounts and additionally enter a personal identification number (PIN) associated with the ATM such that the user's identity is subsequently verified. The transaction statement is similarly associated with the user's account and at least partially details the user's prior transactions processed using the account.

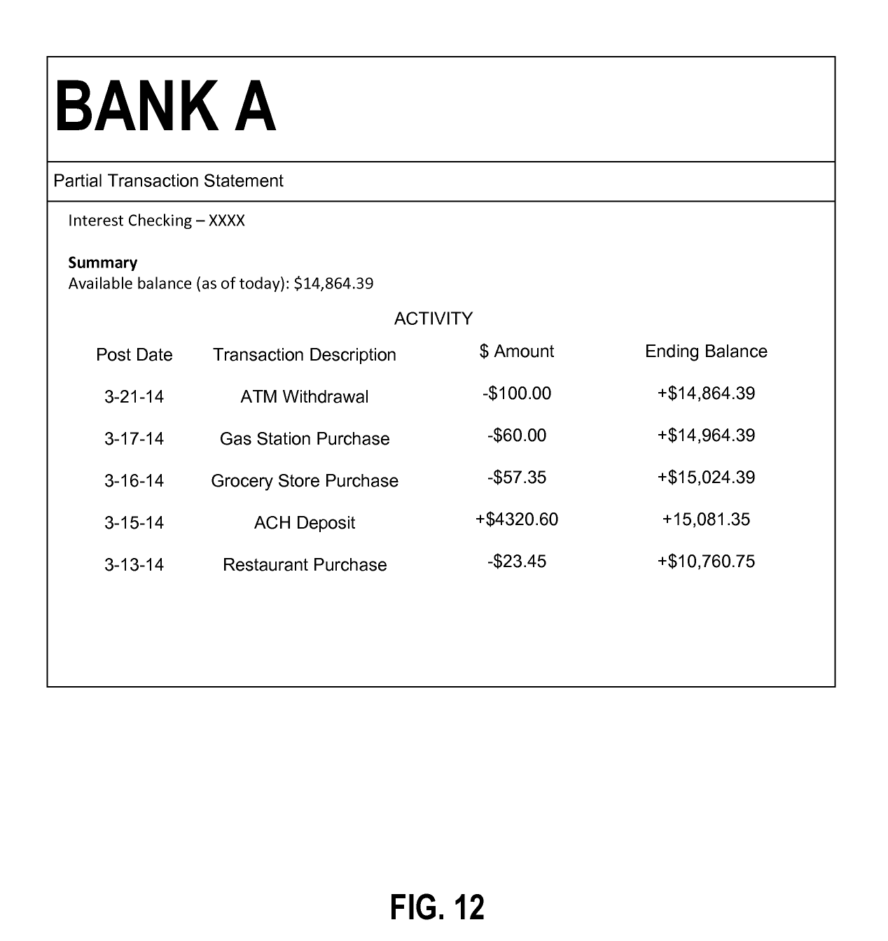

As shown in FIG. 12, the transaction statement may provide a summary of the user's account(s), associated interest rates, and a detailed view of the account activity/history presented via a plurality of line items that detail each individual transaction associated with the account. In an instance that the user has more than one account with the financial institution, the account summary may include a summary of a plurality of user accounts. The account summary may provide several account details including, but not limited to, a description of the account type, the account number, the current balance, the beginning balance with respect to the start the of the statement cycle, the ending balance with respect to the end of the statement cycle, the total amount of account debits within the statement cycles, the total amount of account credits within the statement cycle, and the like. For a specific account, the system may then provide a plurality of line items that detail each individual transaction associated with the account. The account specific transaction statement may provide several account details including, but not limited to, the beginning balance with respect to the start the of the statement cycle, the interest period, number of days in the interest period, amount of interest earned to date, transaction description(s), transaction amount(s), transaction post date(s), transaction effective date(s), ending balance after processing one or more transactions, and the like. In one embodiment, the specific account for which the transaction statement view is request is the account that the user initially authenticated at the ATM when initiating the ATM session. In another embodiment, the specific account is an account that the user selects from within the ATM regardless of the account initially authenticated at the ATM when initiating the ATM session. For example, the user may insert an ATM card within the ATM that is associated with his or her checking account and additionally enter a personal identification number (PIN) to authenticate the user's identity and initiate an ATM session. The user may then select, from within the ATM session, to view a transaction statement for his or her savings account that is also maintained by the financial institution.

The first request from the user to view a transaction statement may comprise a plurality of request details or specifications for retrieving the transaction statement details. In one embodiment, the first request may specify that the user is requesting to view a full transaction statement for the current statement cycle. As used herein, the phrase “statement cycle” may refer to the span or period of time (e.g., number of days, weeks, months, etc.) for which a full account statement detailing account activity is generated. The statement cycle may be defined by the financial institution associated with the account, the user, a third party entity, or the like. The system may then retrieve account and transaction details for transactions within the current statement cycle up to the current date that the user request is being made. For example, if the statements cycle is defined as a monthly period, and the user request to view a full transaction statement on the 15^{th} day of the month, the full transaction statement will comprise details for transactions processed between the 1^{st} day of the month and the 15^{th} day of the month. In one embodiment, the first request may specify that the user is requesting to view a full transaction statement for a past statement cycle. The system may then retrieve account and transaction details for transactions within the statement cycle of a period of time in the past. For example, if the statements cycle is defined as a monthly period, and the user request to view a full transaction statement on September 2^{nd} for the prior statement cycle, the full transaction statement for the prior statement cycle will comprise details for transactions processed between the 1^{st} day of August and the 31^{st} day of August.

In another embodiment, the first request may specify that the user is requesting to view a partial transaction statement. The partial transaction statement may include a various numbers of transactions as requested by the user. The partial transaction statement may include transactions based on a predefined number, period of time, or one or more transaction details (e.g., date, time, amount range, associated merchant, and the like). The system may then retrieve account and transaction details for the number of transactions as defined in the user request. For example, the user may request to view a partial transaction statement for the last ten (10) days, the system may then retrieve account and transaction details for transactions that are within the past ten (10) days from the date that the user submitted the request. Though the partial transaction statement may be generated based on one or more specifications or preferences of the user, it should be also noted that the partial transaction statement may include various numbers of transactions as defined by the financial institution, or a third party entity. For example, the financial institution may define a partial transaction statement as the last five (5) transactions processed and/or pending within the user's account. Upon requesting to view a partial statement, the system may then retrieve account and transaction details for the past five (5) transactions associated with the specified account.

After receiving a first request from the user to view a transaction statement and subsequently retrieving the related transaction details, the system may then present the transaction statement on a display associated with the ATM at step 1120. In some embodiments, the ATM display is a touch screen display that allows the user to not only view the transaction details but directly interact with the transaction statement to execute additional actions. For example, the user may select a particular line item within the transaction statement and view additional details for the individual transaction that corresponds to the line item by directly touching the line item on the touch screen. In an instance that the display is not a touch screen display, the user may interact with the transaction statement using a plurality of other devices or features integrated within the ATM (e.g., keyboard, one or more buttons, voice recognition, and the like). For example, the user may select a particular line item within the transaction statement and view additional details for the individual transaction that corresponds to the line item by navigating the transaction statement using one or more tabs on a keyboard associated with the ATM and selecting the particular line item by pressing an “enter” button after the line item has been highlighted.

In some embodiments, the display is not large enough to present a fully detailed transaction statement. As such, when the transaction statement is initially presented, some transaction details may be truncated on the display screen. In such an embodiment, the user may then request to view additional details of any truncated line item within the presented transaction statement. Alternatively, in some embodiments, instead of simultaneously presenting multiple line items of the transaction statement on the display screen, the system may present line items one at a time and allow the user to tab through the transaction statement using a “next” selection or button feature. The user may additionally define a number of items to be presented on the screen. For example, the user may specify through predefined user preferences that only three transactions and or line items should be displayed on the ATM at once. The user preferences may be specified either at the ATM, via online banking, within a banking branch, banking call center, or various other means for contacting and interacting with the financial institution.

In some embodiments, the transaction details and generally the transaction statement are presented on the display for viewing according to one or more details specified in the first user request. As previously mentioned, the request to view a transaction may specify that the system present a full transaction statement for a particular cycle as defined by the financial institution, a partial transaction statement including one or more transactions based on a predefined number, period of time, or one or more transaction details (e.g., date, time, amount range, associated merchant, and the like) as defined by the user. The user may additionally specify a number of preferences for presenting transactions on the ATM display outside of the request to view the transaction details. In some embodiments, the user display and/or customization preferences are submitted and processed prior to the user arriving at the ATM. The user display preferences may be specified either at the ATM, via online banking, within a banking branch, banking call center, or various other means for contacting and interacting with the financial institution.

In one embodiment, the user preferences specify that the system should highlight a particular transaction type within the transaction statement. For example, the system may highlight all line items associated with deposit transactions. In another embodiment, the user preferences specify that the system should highlight any transaction within the transaction statement that exceeds a predefined amount of money. For example, the system may highlight all line items associated with debit transactions that exceed one hundred dollars ($100). By highlighting particular line items of interest to the user, the system may quickly focus the user's attention to items of interest, reducing the time that the user spends at the ATM viewing the transaction statement, and subsequently reduce the waiting time for other customers waiting to use the ATM.

In yet another embodiment, the user preferences specify the type of transaction details to be presented within the transaction statement. As such, in some instances it is beneficial for the user to specify the specific types of transaction details that are of interest to them when conducting a quick inquiry of his or her transaction history at the ATM. For example, the user may request that the system only present transaction details such as a brief transaction description, transaction amount, and effective date. By excluding transaction details that are not of immediate interest to the user while they are at the ATM, the system may quickly focus the user's attention to the transaction details of interest. Thus, reducing the time that the user spends at the ATM viewing the transaction statement line item, and subsequently reduce the waiting time for other customers waiting to use the ATM. In such an embodiment, the excluded transaction details may still be available to the user upon an additional request to view more detailed information about any given line item and or transaction. The full transaction details simply might not be initially displayed to the user, which in turn eliminates and/or reduces an excess of unnecessary information within the transaction statement being presented on the display of the ATM.

In one embodiment, only transactions retrieved during the initial user request are available to be presented on the display of the ATM. However, in an alternative embodiment, the user request to view the transaction statement is fairly general such that any items available for view within the transaction history/account activity are presented on the display of the ATM. In some embodiments, this may include transaction details for several statement cycles. In such an embodiment, after the number lines items have been initially presented on the display of the ATM, the user may then customize and or modify the transaction statement, or his or her preferences for the types of transactions to be displayed during the current ATM session, in real time during the ATM session. In some embodiments, this requires submitting a request to modify the transaction statement presented and/or customize the transaction statement view. The request may be submitted, in real time at the ATM, using one or more interface device integrated within the ATM (e.g., using a touch screen display, keyboard, voice commands, and the like).

In some embodiments, the additional request to modify the transaction statement presented and/or customize the transaction statement view comprises a request to filter the transaction statement. The transaction statement may be filtered based upon several transaction details associated with each transaction line item. The filter categories may include, but not be limited to, transaction posted date, transaction effective date, transaction type (e.g., credits, debits, ACH deposits, and the like), transaction amount, transaction time stamp, transaction location, a range of transaction amounts, a transaction threshold, merchant name, merchant type, and the like. In such an embodiment, the ATM may be configured to receive for the user, a user input that further defines at least one of the filter categories used to the filter the transaction statement. The user input may be received, in real time at the ATM, and submitted using one or more device integrated within the ATM (e.g., touch screen display, keyboard, voice commands, and the like). For example, the user may select to filter the transaction statement based on a transaction threshold amount, the ATM may then request that the user define the threshold amount, and a filter parameter that defines whether or not transactions above or below the threshold amount should be filtered through the transaction statement. The user may then use a keyboard integrated within the ATM to type in one hundred dollars ($100) as the threshold amount, and specify that transactions below ($100) should be filtered from the transaction statement. The system may then filter the transaction statement based on the user input by excluding any transactions that are below the amount of one hundred dollars ($100). In one embodiment, the user may filter the transaction statement based on a plurality of filter categories. For example, the user may select to filter the transaction statement based on the transaction effective date and the merchant type, the ATM may then request that the user define a date range, and a merchant type specifying the transactions that should be filtered through the transaction statement. The user may then use a keyboard integrated within the ATM to type in a defined date range, and specify gas stations as the merchant type. The system may then filter the transaction statement based on the user input by excluding any transactions that are outside of the defined date range, and not a transaction from a gas station.

In some embodiments the additional request to modify the transaction statement presented and/or customize the transaction statement view includes a request to sort the transaction statement. The transaction statement may be sorted based upon several transaction details associated with each transaction line item. The sort categories may include, but not be limited to, transaction posted date, transaction effective date, transaction type (e.g., credits, debits, ACH deposits, and the like), transaction amount, transaction time stamp, transaction location, merchant name, merchant type, and the like. In such an embodiment, the ATM may be configured to receive from the user, a user input that further defines at least one of the sort categories used to the sort the transaction statement. The user input may be received, in real time at the ATM, and submitted using one or more device integrated within the ATM (e.g., via a touch screen display, keyboard, voice commands, and the like). For example, the user may select to sort the transaction statement based on a transaction amount. The ATM may then request that the user define a sort parameter that defines whether or not transaction should be sorted from greatest to least or from least to greatest. The user may then use a touch screen display integrated within the ATM to specify that transactions should be sorted from greatest to least. The system may then sort the transaction statement based on the user input by presenting the transactions in numerical order from greatest to least. In one embodiment, the user may sort the transaction statement based on a plurality of sort categories. For example, the user may select to sort the transaction statement based on the transaction location and the merchant name, the ATM may then request that the user define a central location (e.g., home address, current ATM location, local branch location, and the like), a location parameter that specifies how the transactions should be sorted, and a sort parameter that defines whether or not transaction should be sorted from A to Z or from Z to A. The user may then use a keyboard integrated within the ATM to define the ATM location as the central location, and specify that the transaction should be sorted from transaction closest to the ATM to transaction that are the furthest from the ATM, with the associated merchant name being sorted from A to Z. The system may then sort the transaction statement based on the user input.

In some embodiments the additional request to modify the transaction statement presented and/or customize the transaction statement view comprises a request to modify the transaction statement based on multiple factors. For example, the transaction statement may be filtered and subsequently sorted based upon several transaction details associated with each transaction line item. In some embodiments the additional request to modify the transaction statement presented and/or customize the transaction statement view comprises a request to include transactions that were excluded when the transaction statement was initially presented on the display of the ATM. For example, the user's predefined preferences may specify that only the last ten (10) transactions be presented such that any transaction that exceeds the last ten (10) transactions are excluded when the transaction statement is initially presented on the display of the ATM. The user may then request that the system presented an additional five (5) prior transactions within the transaction statement view. In another example, the transaction statement may only include transactions that have been processed on the user's account such that any pending transactions are excluded when the transaction statement is initially presented on the display of the ATM. The user may then request that the system present both processed and pending transactions within the transaction statement view. In such an embodiment, the system may only have enough information to present limited transaction details for the pending transactions being that the transactions have not yet cleared and/or been completely processed within the user's account.

After presenting the transaction statement on a display associated with the ATM 1120, the system may then receiving a second request from the user to select at least one line item within the transaction statement for inquiry processing 1130. Inquiry processing may refer to several additional actions being executed by the system via the ATM to offer the user additional information concerning his or her transaction history. As previously mentioned, the ATM may be configured such that the user is able to interact with the displayed transaction statement for the purpose of selecting one or more line items within the transaction statement for further inquiry processing. For example, the user may select a particular line item within the transaction statement and view additional details for the individual transaction that corresponds to the line item by directly touching the line item on the touch screen. In an instance that the display is not a touch screen display, the user may interact with the transaction statement using a plurality of other devices or features integrated within the ATM (e.g., keyboard, voice recognition, and the like). For example, the user may select a particular line item within the transaction statement and view additional details for the individual transaction that corresponds to the line item by navigating the transaction statement using one or more tabs on a keyboard associated with the ATM to and selecting the particular line item by pressing an “enter” button after the line item has been highlighted.

In some embodiments, the user may utilize a “select all” feature and/or option for selecting transactions and/or line items for further inquiry processing. In some embodiment the select all feature may refer to selecting all of the transaction items that have been retrieved during the user request to view the transaction statement. For example, if the system initially retrieved transactions associated with a full transaction statement for the current statement cycle, the select all feature may subsequently select each transaction within the full transaction statement for further inquiry processing. In another embodiment, the select all feature may refer to selecting all of the items that are currently being presented on the display of the ATM. For example, if the user preferences specify that only three (3) transactions and or line items should be displayed on the ATM at once, the select all feature may refer to selecting the three (3) line items that are being currently presented on the display of the ATM for further inquiry processing. In yet another embodiment the select all feature may refer to selecting all of the transaction items that have been retained after modifying and/or customizing the presented transaction statement. For example, if the system initially retrieved transactions associated with a full transaction statement for the current statement cycle and the user filters the transaction statement to exclude a plurality of transactions, the select all feature may subsequently select only the transactions that have been retained after applying the filter to the initially presented transaction statement.

In some embodiments, the user may individually select transactions and/or line items for further inquiry processing. In one embodiment, the user may select transactions based on his or her own discretion specified via user input. For example, the user may navigate through a presented transaction statement and highlight any given transaction for further inquiry processing. In another embodiment, the user may additionally select transactions based on one or more trends that have been detected by the system. For example, the system may be configured to determine the user's normal transaction habit such that any transactions that are outside of the norm based upon a trend of the user's normal transaction habits may be automatically highlight and marked as abnormal transactions. In such an embodiment, the system may automatically select the abnormal transactions for further inquiry processing, or the user may intervene by manually excluding any transactions that the user can verify as non-suspicious or normal. The remaining transactions may then be selecting for further inquiry processing.

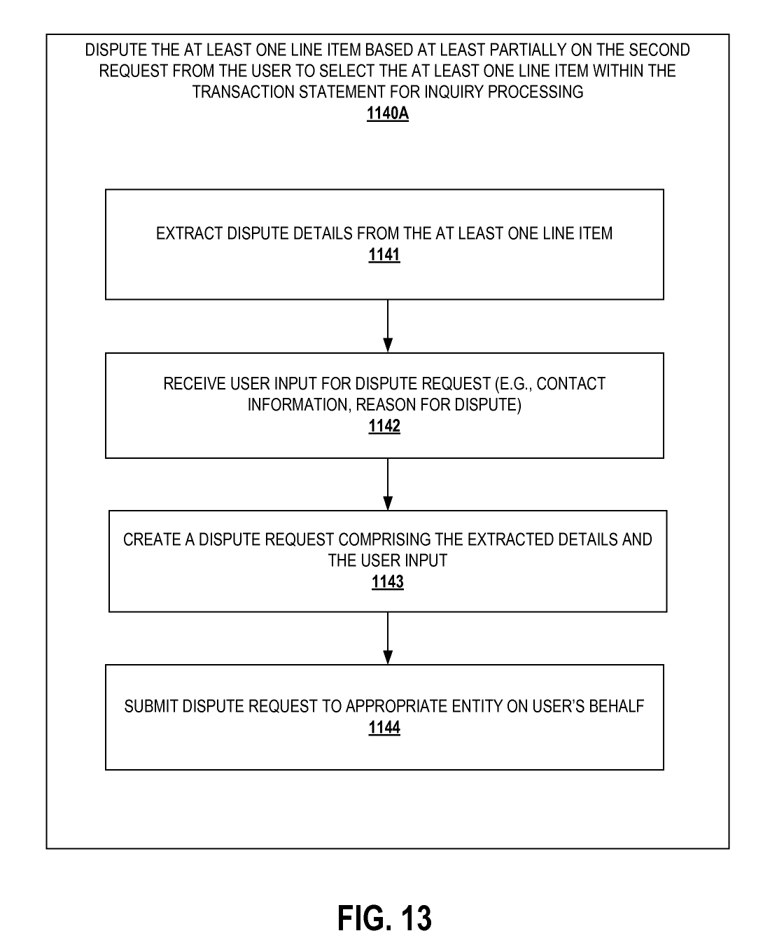

After receiving a second request from the user to select at least one line item within the transaction statement for inquiry processing 1130, the system may then process at least one action for the at least one line item based at least partially on the second request from the user to select the at least one line item within the transaction statement for inquiry processing 1140. The processed actions may include but not be limited to creating and/or transmitting electronic documents, flagging transactions for follow-up, disputing transactions (e.g., as depicted in step 1140A of FIG. 13), and the like. In this way, the processed actions may result in the user receiving additional documents for the selected transactions and/or submitting one or more request for the selected transactions. In some embodiments, the processed actions are a predefined set of actions, as defined by the financial institution that have been made available to the user based upon the user's account type. For example, a user with a standard checking account may only be able to process a limited range of actions from within the ATM session, whereas a user with a premium checking account may have the ability to process the full range of actions, as defined by the financial institution, from within the ATM session. In another embodiment, the processed actions are a predefined set of actions, as defined by the user that are made available to the user based on a user request. For example, in one embodiment, the user may assign and/or activate a range of actions from within his or her online banking account to be available for processing during an ATM session. In such an embodiment, the activation of any given action type may be contingent upon prior approval by the financial institution. For example, the user may request to activate an action to be available for processing during an ATM session, wherein the action allows the user to dispute transactions during the ATM session. The financial institution may the grant the user the right to dispute transactions based upon a previous number of transactions disputed during a predetermined period of time, where a user that frequently disputes transactions may be denied the right to activate an action. Similarly, the financial institution may initially grant the user the right to dispute transaction from within ATM sessions, and later revoke the right based upon the user excessively increasing his or her number of transaction disputes. By selectively allowing the user to process certain transactions from within the ATM session, the system may be able to better allocate resources responsible for processing the transactions on the back end of the system.

In some embodiments, the at least one action processed for the selected line item(s) comprises creating a portable document format (PDF) document that contains transaction details associated with the selected line item(s). The user may select either a full or partial statement such that the system creates a PDF document containing the transaction details of the line items that have been retained and selected within the transaction statement. After creating the transaction statement PDF document, the system is further configured to transmit the transaction statement PDF document to the user. Methods of transmitting the transaction statement PDF document to the user may include, but not be limited to email, text messaging, multimedia messaging, or other methods for digitally sharing content that have not been expressly contemplated herein. For example, the user may specify a request to receive the transaction statement PDF document via email, the user may then use a keyboard integrated within the ATM to provide an email address to which the PDF document should be sent. In an alternative example, the user may provide a default email address in his or her user preferences for communicating documents (e.g., transaction statements) during inquiry processing such that the statement PDF document is automatically sent to the default email address. In another embodiment, the user may receive the request to receive a hyperlink that references a location of the PDF document, where the user can later access the PDF document and perform a number of functions (e.g., saving, printing, editing, and the like). In such an embodiment, the hyperlink may be active for a predetermined period of time allowing the user to access the transaction statement PDF document. For example, the system may electronically transmit a hyperlink that references the transaction statement PDF document that is accessible for five (5) days after being sent. It should be noted that although in the exemplary embodiment the system creates a PDF document that contains the transaction details associated with the selected line items, the system may additionally create a document of any other document type containing the transaction details including but not limited to any text and/or image file extension type.

In some embodiments, the at least one action processed for the selected line item(s) includes flagging the selected line items(s) for follow-up. The user may request to flag one or more line items that have been retained and selected within the transaction statement for follow-up at a later date. Flagging the line items for follow-up may include associating the line items with a visual identifier that specifies the corresponding transaction as a pertinent item of interest. For example, the system may either highlight the line item, convert the current line item font to bold print, denote the line item with a character symbol (e.g., a flag, checkmark, asterisk, and the like), and the like as visual identifiers that specify the corresponding transaction as a pertinent item of interest. After flagging the line item(s), the system is further configured to receive one or more notes to associate with the flagged line items that detail the user's concern or reasoning for flagging a particular line item. The notes may then be reviewed by either by the user or personnel within the financial institution or another third party entity. For example, the user may question the amount of a particular transaction while reviewing the presented transaction statement, flag the transaction for later review, and provide a note to be associated with the transaction that reminds the user to compare the transaction amount with the amount of the transaction as printed on a corresponding receipt. The system may then subsequently highlight the transaction and indicate that the flagged transaction has a detailed note attachment.

In some embodiments, the at least one action processed for the selected line item(s) includes unflagging at least one flagged line items(s). The user or other personnel may request to remove the flag of one or more line items that have been previously flagged after the user's issue and/or concern with the transaction has been addressed. Unflagging the line items may include disassociating the line items with a visual identifier that previously specified the corresponding transaction as a pertinent item of interest. For example, the system may either remove the highlight the line item, return the current line item font to normal print, remove a character symbol (e.g., a flag, checkmark, asterisk, and the like) associated with the line item, and the like such that the line item is not associated with a visual identifier. After unflagging the line item(s), the system may be further configured to remove one or more notes associated with the line items when it was initially flagged. For example, the user may question the amount of a particular transaction while reviewing the presented transaction statement, flag the transaction for later review, and provide a note to be associated with the transaction that reminds the user to compare the transaction amount with the amount of the transaction as was printed on a corresponding receipt. After comparing the transaction amount of the transaction with the transaction amount shown on the receipt, the user may determine the amount is correct, and remove the flag associated with the line item.

In some embodiments, the at least one action processed for the selected line item(s) includes disputing the selected line items(s). In some embodiments, as illustrated in FIG. 13, disputing a transaction may include several steps including, but not limited to, extracting dispute details from at least one line item at step 1141, receiving user input for a dispute request at step 1142, creating a dispute request including the extracted details and the user input at step 1143, and submitting the dispute request to an appropriate entity on the user's behalf at step 1144, which may be explained in further detail herein. The user may request to dispute one or more line items that have been retained and selected within the transaction statement. Disputing the selected line item(s) may include the system extracting dispute details from the transaction line item and submitting/transmitting the information to the financial institution on behalf of the user as a transaction dispute request. The user may request to dispute either a single transaction or a group of transactions from within the ATM session. For example, the user may identify a particular line item for dispute; the system may then extract information such as the dollar amount of the suspected transaction and/or transaction error, the posting date of the transaction, and the like. The system may then subsequently submit/transmit the information to the financial institution on behalf of the user as a transaction dispute request. In typical embodiments, the system is further configured to receive user input from the user regarding the dispute request, such as additional information to be associated and/or included in the dispute request. For example, a user may specify a description of the error and an explanation of why they believe there is an error with the transaction. In some embodiments, the dispute process requires the user receiving a call or follow-up from the financial institution in response submitting the transaction request. In such an embodiment, the system may be further configured to receive from the user contact information (e.g., telephone number, email address, best time of day for contact and the like) to be associated and/or included in the dispute request. For example, a user may provide and specify his or her mobile phone number may be contacted between 5 pm and 9 pm, and provide and specify his or her work number as preferred contact number between 8 am and 5 pm. In some embodiments, the system may deny a user request to dispute a transaction based at least partially on one or more rules predefined by the financial institution. For example, the financial institution may specify that transactions must be disputed within 60 days of the date of the statement where the error appeared. As such, the system may prohibit the user from disputing transactions from within the ATM session that were processed more than 60 days of the date of the statement where the error appeared. As previously mentioned, in some embodiments, the ability to dispute transactions from within the ATM session may be provided as a service either based on the user's account type or based on the user subscribing to the service. In such an embodiment, the user may be able to opt into and/or out of the service at according to his or her personal discretion.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. An automated teller machine, whereby the automated teller machine processes transaction statement inquiries for users, the automated teller machine comprising:
a memory;
one or more computing processors; and
a module stored in the memory, said module comprising instruction code executable by one or more computing processors, and configured to cause the one or more computing processors to:
receive a first request from a user, via the automated teller machine, to view a transaction statement, wherein the automated teller machine is maintained by a financial institution, and wherein the user has an account with the financial institution;
present the transaction statement on a display associated with the automated teller machine, wherein the transaction statement comprises one or more line items corresponding to one or more transaction associated with the user account;
receive a second request from the user, via the automated teller machine, to select at least one line item within the transaction statement for inquiry processing; and
process at least one action for the at least one line item based at least partially on the second request from the user to select the at least one line item within the transaction statement for inquiry processing.

2. The automated teller machine of claim 1, wherein the module is further configured to cause one or more computing processors to authenticate the user's identity prior to receiving the first request from the user.

3. The automated teller machine of claim 1, wherein the first request comprises one or more user specifications for presenting the transaction statement, and wherein at least one of the specifications comprises a request to present a full transaction statement for the current statement cycle.

4. The automated teller machine of claim 1, wherein the first request comprises one or more user specifications for presenting the transaction statement, and wherein at least one of the specifications comprises a request to present a partial transaction statement based on the one or more user specification.

5. The automated teller machine of claim 1, wherein the module is further configured to cause one or more computing processors to present the transaction statement on the display associated with the automated teller machine based at least partially one or more user preferences, and wherein the user preferences comprise highlighting a particular transaction type within the transaction statement.

6. The automated teller machine of claim 1, wherein the module is further configured to cause one or more computing processors to present the transaction statement on the display associated with the automated teller machine based at least partially one or more user preferences, and wherein the user preferences specify the type of transaction details to be included within the transaction statement.

7. The automated teller machine of claim 1, wherein the module is further configured to cause one or more computing processors to modify the transaction statement in real time based at least partially on a user request to modify the transaction statement presented on the display associated with the automated teller machine.

8. The automated teller machine of claim 7, wherein the user request comprises a request to filter one or more lines items within the transaction statement.

9. The automated teller machine of claim 7, wherein the user request comprises a request to sort one or more lines items within the transaction statement.

10. The automated teller machine of claim 7, wherein the user request comprises a request to present one or more pending transactions within the transaction statement.

11. The automated teller machine of claim 1, wherein the module is further configured to cause one or more computing processors to present the user with an option to select all line items within the transaction statement for inquiry processing.

12. The automated teller machine of claim 1, wherein the module is further configured to cause one or more computing processors to select at least one transaction for inquiry processing based at least partially on one or more trends detected within the user's transaction history.

13. The automated teller machine of claim 1, wherein the at least one action comprises creating a portable document format (PDF) document that contains transaction details for the at least one line item selected.

14. The automated teller machine of claim 1, wherein the at least one action comprises flagging the at least one line item selected for follow-up.

15. The automated teller machine of claim 1, wherein the at least one action comprises disputing the at least one line item selected for follow-up.

16. A method for use in automated teller machines, whereby transaction statement inquiries for users are processed via an automated teller machine, the method comprising:
receiving a first request from a user, via the automated teller machine, to view a transaction statement, wherein the automated teller machine is maintained by a financial institution, and wherein the user has an account with the financial institution;
presenting the transaction statement on a display associated with the automated teller machine, wherein the transaction statement comprises one or more line items corresponding to one or more transaction associated with the user account;
receiving a second request from the user, via the automated teller machine, to select at least one line item within the transaction statement for inquiry processing; and
processing at least one action for the at least one line item based at least partially on the second request from the user to select the at least one line item within the transaction statement for inquiry processing.

17. The method of claim 16, wherein the method further comprises presenting the transaction statement on the display associated with the automated teller machine based at least partially one or more user preferences.

18. A computer program product for use in automated teller machines, whereby transaction statement inquiries for users are processed via an automated teller machine, the computer program product comprising:
a non-transitory computer-readable medium comprising a set of codes for causing a computer to:
receive a first request from a user, via the automated teller machine, to view a transaction statement, wherein the automated teller machine is maintained by a financial institution, and wherein the user has an account with the financial institution;
present the transaction statement on a display associated with the automated teller machine, wherein the transaction statement comprises one or more line items corresponding to one or more transaction associated with the user account;
receive a second request from the user, via the automated teller machine, to select at least one line item within the transaction statement for inquiry processing; and
process at least one action for the at least one line item based at least partially on the second request from the user to select the at least one line item within the transaction statement for inquiry processing.

19. The computer program product of claim 18, wherein the computer program product further comprise a set of codes for causing a computer to present the transaction statement on the display associated with the automated teller machine based at least partially one or more user preferences.
